(19) United States
(12) Patent Application Publication
(10) Pub. No.: US 2013/0117198 A1
(43) Pub. Date: May 9, 2013

(54) Intellectual property method for dollar cost averaging invesetment plan process for ongoing stock investing

(71) Applicant: Diane M. Hogan, Whitehouse Station, NJ (US)

(72) Inventor: Diane M. Hogan, Whitehouse Station, NJ (US)

(21) Appl. No.: 13/373,113

(22) Filed: Nov. 4, 2011

(51) Int. Cl. G06Q 40/06

(52) U.S. Cl. 705/36 R

(57) ABSTRACT

A Dollar Cost Averaging Investment Plan Process for Ongoing Stock Investing builds an investment portfolio over time. The system prompts a user for an account number; investments are made in accordance with the DCA program. The user establishes from numerous parameters the criteria that governs the DCA process. Periodic email transmissions optionally provide for review of and adjustments to standing orders and commissions, or to cancel the standing orders. The system facilitates building an investment portfolio over time with a hands-off approach to investing.

### BACKGROUND OF THE INVENTION

1. Field of the Invention

The present invention relates to an Intellectual Property method for providing an Automatic

Investment Plan order entry process to enable an investor to set-up ongoing buy orders and sell orders into and out of publicly traded securities of any kind that trade on the National Securities Exchange, Foreign Exchange, Regional Exchange, and any Electronic Exchange for a specified dollar, or share amount, and percentage amount (for sell orders only), utilizing the method of Dollar Cost Averaging.

2. Description of the Prior Art Dollar-Cost Averaging (DCA) is a technique generally used in buying a fixed dollar amount of a particular investment on a regularly scheduled basis, regardless of the share price. More shares are purchased when prices are low, and fewer shares are bought when prices are high. Other types of investing include lump sum investing, wherein a lump sum of money is used to purchase shares for a one-time event, rather than regularly. Various investments also provide for multiple purchases of sets containing a number of shares, rather than purchases based on a fixed dollar amount.

Despite these buying or selling techniques, investing in today's markets and our busy society can be difficult due to time constraints. Often hectic schedules prevent individuals from having time to invest in an optimal manner. Most individuals simply do not have the time to devote to their financial goals and objectives even though it should be a priority. Typically investors must constantly monitor their portfolios and enter their security purchase and sale orders over time. Regular daily monitoring of an investment account can be cumbersome and not always feasible as the investor must constantly monitor their portfolios to determine when to buy and sell securities while attending to everyday job functions and responsibilities. Frequently opportunities are lost owing to the failure or the inability to monitor the investment portfolio on a daily basis.

Another problem commonly encountered by investors' results when trading on margin. Trading on margin can be problematic when a debt is created due to a purchase transaction, causing the investor to be charged interest fees.

Improvement in the method used to carry out stock buying and selling is needed in the art. There remains a need in the art for an improved process that allows an investor to set-up an Automatic Dollar Investing and Share Investing Plan into and out of securities that trade on any Securities Exchange on an ongoing scheduled basis. Further, there is a need in the art for an improved process that allows trading on margin to automatically transfer funds to satisfy the debt created from security purchase transactions.

### SUMMARY OF THE INVENTION

The present invention provides a platform appointed to be adapted and integrated into the I.T. Trading Systems for use of all Broker-Dealers, and Electronic Trading systems for online Internet investing that are available for a user/investor. This platform will offer an automatic investment plan order entry process to enable the user/investor to set-up ongoing buy orders and sell orders for a specified dollar amount or share amount, and percentage amount (for sell orders only), into and out of publicly traded securities that trade on any securities exchange utilizing the method of Dollar Cost Averaging. The proposed fee for this service will be 10% of the trading commission the Broker-Dealers charge for their services. The 10% fee can be over and above the commission generated as a surcharge or if the Broker-Dealer so chooses can incorporate the fee (10% of the total commission) within their commission structure losing part of their fee to the licensing of the patent property and not burdening the client with additional charges.

Particularly, the system provides an improved process that allows an investor to setup an automatic Dollar Investing or Share Investing plan into and out of the market. Further, the system provides an improved process that allows trading on margin to automatically transfer funds from another external funding source (such as a Bank or Broker-Dealer) when the investor wants to avoid interest fees when a debt is created from purchase transactions.

The present invention relates to an Intellectual Property method for providing an Automatic Investment Plan order entry process to enable an investor to set-up ongoing buy orders and sell orders into and out of publicly traded securities that trade on any National Securities Exchange, Foreign Exchange, and Electronic Exchange for a specified dollar, or share amount, and percentage amount (for sell orders only), utilizing the method of Dollar Cost Averaging. This will include any publicly traded security, in the secondary market after it's IPO (Initial Public Offering), such as individual Stock and ETF's (Exchange Traded Funds), that trade on any Securities Exchange such as the NYSE (New York Stock Exchange), the NASDAQ (National Association of Securities Dealers Automated Quotation system), any National Regional Stock Exchange, Foreign Exchange, and Electronic Exchange for a specified period of time utilizing the method of Dollar Cost Averaging. This is similar to the concept of a 401k-retirement program when money is taken from an employee's income each pay-period and invested over time into their choice of securities offered in their plan. However, this process will allow the user/investor to purchase and sell any publicly traded security that trades on the NYSE, NASDAQ, any National Regional Exchange, Foreign Exchange, and Electronic Exchange in any type of trading account (adhering to the Rules and Regulations of the NYSE, SEC (Securities and Exchange Commission), FINRA (Financial Industry Regulatory Authority), and the SRO (Self-Regulatory Organization)), and affording them the opportunity to create a nest egg overtime without constantly monitoring their investment portfolio. Through use of the subject system and process, the Broker-Dealers/end users will be able to interface the process with their trading systems in order to offer such a service to their clients for a fee of 10% of the trading commission generated when orders are executed. The 10% fee can be over and above the commission generated as a surcharge or the Broker-Dealer/end-user can incorporate the fee (10% of the total commission) within their commission structure losing part of their fee to the licensing of the patent property and not burdening the client with additional charges.

A system for implementing a Dollar Cost Averaging (DCA) Investment Plan Process for Ongoing Stock Investing over time is provided. The system comprises of an order platform to create an automatic investment plan utilizing the method of Dollar Cost Averaging will include the following data to be integrated into I.T. systems for all Broker-Dealers and Electronic Trading systems for online Internet investing that are available for the user/investor. Receive: Account Number entry means for a user/investor to transact business in their selected account, Receive: Action transaction type means for Buy, Sell, Change/Cancel to indicate the action to be taken, Receive: Stock/ETF Symbol entry means to invest using the mnemonic trading symbol (ex. IBM) for the publically traded security, Receive Quantity: Share Quantity, Dollar Quantity, Percentage Quantity (sell orders only) for Dollar Cost Average entry means stated in share amount, dollar amount, and a percentage of shares (for sell orders) based on the number of shares held in the account at any given time or selected by the user/investor, Receive Maximum Investment Criteria: Maximum Shares or Maximum Dollars to include an accumulation total of the maximum shares or dollars the user/investor wants to buy or sell on a selected security, Receive: Start and End Dates from Calendar: Starting Date entry means to begin a Dollar Cost Average program (ex. 09/30/2011), and Ending Date entry means to complete the program (ex. 09/30/2013) both chosen on a pop-up display calendar, Receive: Investment Frequency order entry means to choose how often the user/investors transactions are to take place from a calendar that populates the chosen Criteria: Daily, 4 Days/Week, 3 Days/Week, 2 Days/Week, 1 Day/Week, Monthly (Select Date(s) to automatically populate all months within time frame of order), or Other (Select Random Date(s)), Order Price entry means to choose a Market or Limit order with the flexibility to choose the Hour and Minute to transact the order between 9:30a.m. and 4:00 p.m., or At Opening Price, or At Closing Price, or Limit Or Better price that the user/investor selects and must trade at the stated price to allow the order to be filled. The system further includes optional order choices for both buy and sell orders; Receive: Optional Order Choices for Buy Order: Reinvest Dividends entry means, Do Not Reduced for Dividend Adjustments entry means, Buy in Cash A/C entry means, Buy in Margin A/C (if available) entry means and maybe subject to interest charges if debt is created, Minimum Share Quantity entry means noting the least amount of shares to buy or sell on a limit order, All or None entry means to fill all shares or none at all for both buy and sell limit orders; Optional Order Choices for Sell Order: Cost Basis entry means that defaults to First In First Out if user/investor does not select from the following choices: FIFO (default) shares purchases first and sold first, LIFO shares purchased last and sold first, HIGH COST shares with highest cost basis sold first, LOW COST shares with lowest cost basis sold first, TAX LOT OPTIMIZER lots are selected & sold with the objective of taking losses first and gains last, SPECIFIED LOT to assign specific lots to be sold at the time of trade up to and including settlement date, Receive: Optional Funding Features In/Out from External Account entry means to set-up an external bank/brokerage account to link funds to settle purchases created from DCA and to avoid interest fees if purchased on margin, and to also have the ability to send funds upon settlement out to the external financial institution when sale proceeds are created from DCA, Name of Bank/Broker entry means for user/investor to fill in required information of the name of the external financial institution, Bank/Broker ABA# entry means to move funds between institutions, Bank/Broker Account # entry means to debit or credit funds from or to the external financial institution, For Further Credit In/Out to External Account such as a brokerage account to be credit or debit, Authorize Transfer of Debt created INTO Trading Account on Settlement Date of Transaction entry means giving authorization to move money INTO the trading account upon settlement when a debt is created from a purchase transaction, Maximum Dollars to Transfer INTO trading account on Settlement entry means limiting an amount to transfer INTO the trading a/c to avoid a possible overdrawn issue from the external financial institution, Authorize Transfer of Credit OUT of Trading Account on Settlement Date of Transaction entry means giving authorization to move the credit from a sales transaction OUT to the External Financial Institution upon settlement, Maximum Dollars to Transfer OUT of trading account on Settlement entry means limiting an amount to transfer OUT of the trading a/c to the external institution. Receive: Optional Email Reminder to Review DCA order entry means gives the user/investor a heads-up reminder to check their open orders and make adjustments or simply let them stand: Days to send an email reminder, 14 Days to send an email reminder, 30 Days to send an email reminder, 60 Days to send an email reminder, Other: Enter Days ______ of your choice to send an email reminder of the investors choosing, Enter email address enabling the user/investors emails to be entered/adjusted if not on file, Receive: Optional Broker Use Only to enable the broker to make adjustments/changes to commission, and add notes to display on user/investors confirmation; Commission Adjustments to adjust/change as needed, Notes to Display on Confirmation when user/investor instructs special notes to be added for their records, Select Pre-existing Order means to allow a user/investor to select a standing order, Change/Cancel Order means to adjusts or Cancel the order, Review Order means allows user/investor to review order before submitting it, and Submit Order means allows order to be entered and activated to the exchange.

### DEFINITIONS

A Market order as used herein generally means an order to buy or sell a security at the current market price at the moment the order is received on the floor of the Exchange (NYSE) or through an electronic Exchange method (such as NASDAQ).

A Limit order as used herein generally means an order to buy or sell a security at a specified Limit price or better than the stated limit price.

Exchange-Traded Funds (ETF's) as used herein generally means a security that tracks an index such as the S&P 500, a commodity index like gold and silver, or a basket of assets like a small company index fund, and trades like a stock on the Exchange. They have low operating expenses and do not have a portfolio manager's expenses. They can be traded on margin and may be sold short unlike a mutual fund. ETF shares or units experience price changes throughout the day as they are bought and sold.

Lump Sum investing as used herein generally means a technique used in buying stock on a one-time event with a lump sum of money.

Security or Stock as used herein generally means any stock or shareholder equity, Exchange Traded Fund (ETF), and any issue that an investor can buy and sell on the NYSE, NASDAQ, any National

Regional, Foreign, and Electronic Exchange that uses a mnemonic trading symbol (ex. IBM) to transact business.

Dollar Cost Averaging (DCA) as used herein generally means a technique used in buying or selling a fixed Dollar amount on any publicly traded security (stock and ETF's) on a regularly scheduled basis regardless of the share price, i.e. buying or selling $50 of XYZ stock every Friday at 11:00 a.m. at the Market price.

Settlement Date is the date upon which a trade settles and creates a debit or a credit in a brokerage account. The trades settle in T+3 or Trade date plus 3 business days for Stock and ETF's whether buying or selling.

DCA is being taken to a new level in this proposed process for not only buying and selling a fixed dollar amount but also allowing for buying and selling a fixed share amount regardless of the price per share, i.e. buying or selling 15 shares of XYZ stock Wednesday & Friday at 10:00 a.m. at the Market starting Aug. 15, 2011 and ending Dec. 15, 2012. Orders can be placed at the Market or at a Limit price as stated by the user/investor. A Limit price may not transact if the price per share is in excess of the Limit price entered on a buy order or less than the stated price on a sell order. And for sell orders only, having the ability of selling a percentage of shares owned in the account to be sold over time through DCA, i.e. selling 5% of current share holdings of XYZ stock in the account monthly, at the market price, starting Aug. 8, 2011, on Monday's at 10:00 a.m. through Mar. 8, 2012.

### BRIEF DESCRIPTION OF DRAWINGS

The invention will be more fully understood and further advantages will become apparent when reference is had to the following detailed description of the preferred embodiments and the accompanying drawings, in which

FIG. 1 is a flow chart illustrating a preferred embodiment of the present invention;

FIG. 2 is an example of an order entry for Dollar Cost Averaging on a Buy Order;

FIG. 3-A is an order Entry Platform (using example in FIG. 2) using the subject Dollar Cost Averaging Investment Plan Process for Ongoing Stock Investing;

FIG. 3-B is a continuation of FIG. 3-A;

FIG. 3-C is a continuation of FIG. 3-B;

FIG. 3-D is a continuation of FIG. 3-C;

FIG. 4-A illustrates Trade results of the order example of FIGS. 3-A through 3-D;

FIG. 4-B illustrates an email sent for review of the standing order of FIG. 4-A for 60 days for months December through January;

FIG. 4-C illustrates an email sent for review of the standing order of FIG. 4-A for 60 days for months February through March;

FIG. 4-D illustrates an email sent for review of the standing order of FIG. 4-A for 60 days for months April through June, ending June 29^{th}, with final results posted;

FIG. 5 is an example of an order entry for Dollar Cost Averaging on a Sell Order;

FIG. 6-A is an order Entry Platform (using example in FIG. 5) using the subject Dollar Cost Averaging Investment Plan Process for Ongoing Stock Investing;

FIG. 6-B is a continuation of FIG. 6-A;

FIG. 6-C is a continuation of FIG. 6-B;

FIG. 6-D is a continuation of FIG. 6-C;

FIG. 6-E is a continuation of FIG. 6-D;

FIG. 7-A illustrates Trade results of the order example of FIGS. 6-A through 6-E;

FIG. 7-B illustrates an email sent for review of the standing order of FIG. 7-A for 60 days for months January through March;

FIG. 7-C illustrates an email sent for review of the standing order of FIG. 7-A for 60 days for months March through May, ending May 11th, with final results posted;

FIG. 8 is an example of an order entry for Dollar Cost Averaging on a Percentage of Shares Sell Order;

FIG. 9-A is an order Entry Platform (using example in FIG. 8) using the subject Dollar Cost Averaging Investment Plan Process for Ongoing Stock Investing;

FIG. 9-B is a continuation of FIG. 9-A;

FIG. 9-C is a continuation of FIG. 9-B;

FIG. 9-D is a continuation of FIG. 9-C;

FIG. 9-E is a continuation of FIG. 9-D;

FIG. 10-A illustrates Trade results of the order example of FIGS. 9-A through 9-E;

FIG. 10-B illustrates an email sent for review of the standing order of FIG. 10-A for 30 days;

FIG. 10-C illustrates an email sent for review of the standing order of FIG. 10-A for next 30 days;

FIG. 10-D illustrates an email sent for review of the standing order of FIG. 10-A for next 30 days;

FIG. 10-E illustrates an email sent for review of the standing order of FIG. 10-A for next 30days;

FIG. 10-F illustrates an email sent for review of the standing order of FIG. 10-A for next 30 days, with final results posted;

FIG. 11 is a block diagram of the computerized system of the present invention.

### DESCRIPTION OF THE PREFERRED EMBODIMENTS

The present invention provides a proposed Intellectual Property platform that will offer an automatic investment plan order entry process to enable the user/investor to set-up ongoing buy orders and sell orders for a specified share or dollar amount, and percentage amounts for sale of securities only, with the choice of a number of time parameters available for beginning and ending means, into and out of publicly traded securities (Stock and ETF's) that trade on any exchange (NYSE, NASDAQ, any National Regional Exchange, Foreign and Electronic Exchange), which has a mnemonic trading symbol (such as IBM) utilizing the method of Dollar Cost Averaging (DCA). This proposed licensed Intellectual Property platform will be adhered to, as suggested in this process, adapted and integrated into the I.T. Trading Systems Network of Broker-Dealers and any online Electronic Internet Trading systems that are available for the user/investor may readily implement the subject process and system.

In Dollar Cost Averaging, the user/investor generally decides a number of parameters: the fixed amount of money or shares invested each time in or out of the market, the investment frequency, the time horizon over which all of the investments are made, and with this invention allows for multiple criteria of choices available. With a shorter time horizon, the strategy behaves more like lump sum investing. Generally, it is considered that the best time when investing in the stock market in terms of balancing return and risk is a minimum of six to twelve months and beyond. One key component to maximizing profits is to include the strategy of buying during a down-trending market, using a scaled formula to buy more shares as the price falls. Then, as the trend shifts to a higher priced market, use a scaled plan to sell. Timing is everything and patience is the key. And when timing is good, one can often profit over the long run. When time is on a user/investors side, the return over long term investing often creates a nice nest egg of ones future.

The key to this automatic investment plan order entry process is to set-up parameters the user/investor wants to accomplish and not have to think about it until the needs are met. Monitoring is great when a user/investor has time, but so often life has a tendency to get in the way. And with DCA the user/investor will probably be more apt to take a look to see how things are going once the order/s are working for them creating more awareness for their goals and objectives. Also with the use of an email reminder to check on the orders will be an additional help to the user/investors as they monitor their account.

Dollar Cost Averaging will ultimately capture, over a selected period of time, the highs and lows of the market and often creating a greater rate of return over the long run. The method of the subject invention prevents lost opportunities that result from situations wherein a user/investor is too busy to monitor their investments. The process for ongoing stock investing makes available to the general public through all participating NYSE and FINRA member Broker-Dealer firms the ability to both buy into and sell out of any publicly traded security that uses a mnemonic trading symbol (such as IBM) which trades on any Exchange. Through this process for ongoing stock investing of the subject invention virtually everyone will have the flexibility of choosing the security he/she wants to buy into or sell out of over time, while having the choice of selecting the Quantity of Shares or Dollar amount to invest into or out of the market, and having the ability of selling a Percentage amount (sell orders only) of stock/ETF's held in an account, stipulating a maximum investment criteria for shares or dollars, having the choice of a starting and ending date for the process, the investment frequency (ex. daily, 4 days a week, 3 days a week, 2 day a week, 1 days a week, monthly, and random choice), selecting a Market or Limit order and having the ability to stipulate on a market order the hour/minute of the day or open or closing price to execute the order, optional order identifiers such as dividend reinvestment, do not reduce for dividend adjustment, the ability to buy in the cash or margin portion of the account, minimum share quantity, and all or none means. Also upon sales the user/investor's choice of Cost Basis method for tax filings such as FIFO, LIFO, HIGH COST, LOW COST, TAX LOT OPTIMIZER, and SPECIFIED LOTS, linked fiords in/out from external accounts upon settlement of purchases or sales, also selecting an optional email for a reminder to review the outstanding order periodically, and also allowing Broker- Dealers to make adjustments to commissions, and notes to show on a clients confirmation.

The process for ongoing stock investing of the subject invention imparts investment flexibility and allows the user/investor to “set it and forget it” as it is doing all the work without constant monitoring. It gives the small investor a chance to invest and save on their own with minimal Broker intervention to help meet their goals and objectives. This process will also create revenue for the Broker-Dealers as money is being invested and commissions being generated. This process has the potential to help on a large scale as money is being put to work in our economy. It's a Win-Win process as everyone makes out in the end.

Another key advantage of the process for ongoing stock investing of the subject invention provides the ability to protect accounts when a user/investor is trading on margin Trading on margin can be problematic when a debt is created from a purchase transaction causing the investor to be charged interest fees. The process for ongoing stock investing of the subject invention provides the ability for a user/investor to choose where to place his/her trade in either the Cash or the Margin portion of the account, and also allows the user/investor to link an external financial institution to satisfy the debt upon settlement of a purchase or credit upon a sale. This will ultimately give the user/investor the ability to avoid any additional interest charges and to satisfy the debt when created as well as transferring credits to the external account. And the user/investor will also have the ability to stipulate a Maximum amount to transfer (ex $20,000.00 maximum) in or out to the external linked account in order to prevent a potential debt from funding source. Moreover, sometimes the broker needs to adjust the commission or waive fees as well as place notes on the confirmation of a trade for their user/investor records. The process further provides this type of flexibility to the broker. The user/investor can change his/her plan whenever needed or whenever money or shares run out.

The process for ongoing stock investing of the subject invention can optionally include a means for encouraging investors to consolidate their shares being held at a transfer agent, safety deposit box or at home, and/or other financial institutions to consolidate their assets with one Broker-Dealer and set up this inexpensive plan to continue to add to their holdings. By consolidating a user/investor's various accounts and shares, they will ultimately cut out an excessive amount of paperwork and help streamline their personal process on the home front. This is also helpful with our aging society to keep life simple.

The proposed fee for this service will be 10% of the trading commission the Broker-Dealers charge for their services. The 10% fee can be over and above the commission generated as a surcharge or if the Broker-Dealer so chooses can incorporate the fee (10% of the total commission) within their commission structure losing part of their fee to the licensing of the patent property and not burdening the client with additional charges.

The following examples are presented to provide a more complete understanding of the invention. The specific techniques, conditions, and reported data set forth to illustrate the principles and practice of the invention are exemplary and should not be construed as limiting the scope of the invention.

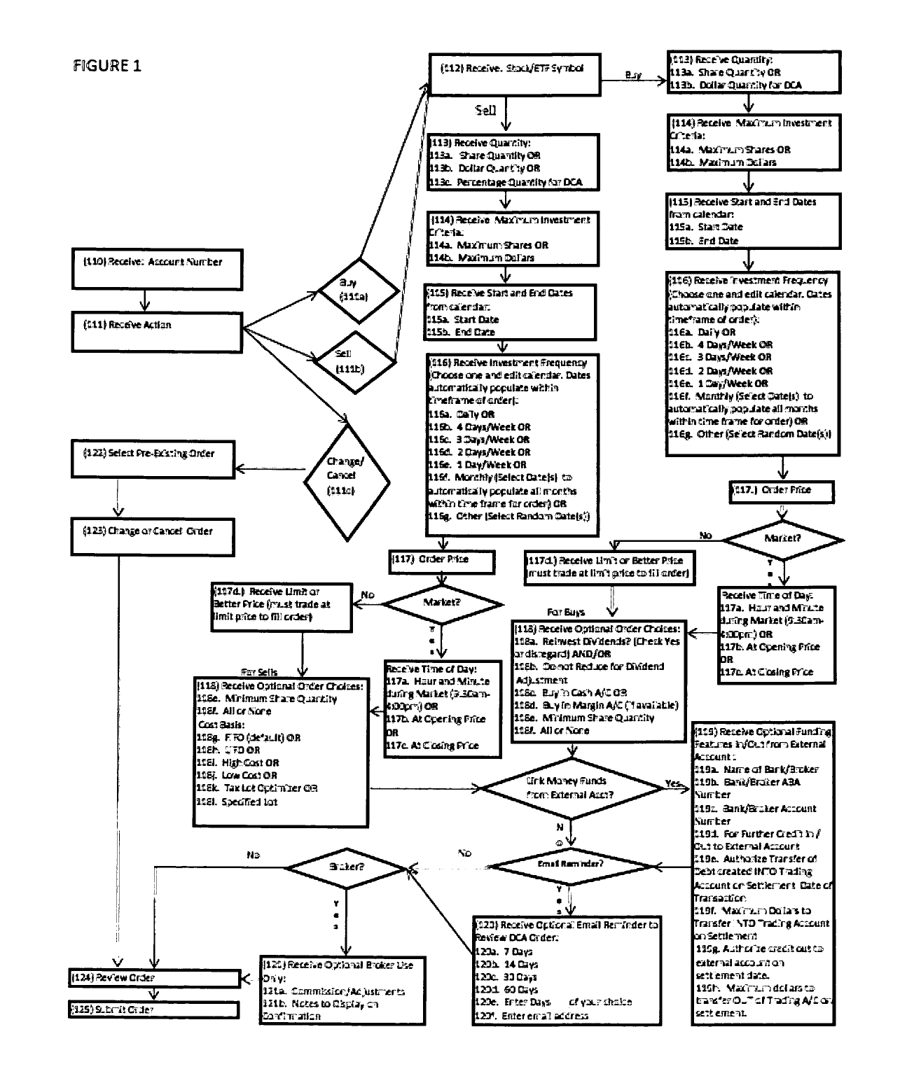

Note the ease and simplicity for a user/investor as demonstrated in FIG. 1 showing the flow chart and illustrating the preferred embodiment of the present invention with the proposed order entry system for providing a Dollar Cost Averaging Investment Plan Process for Ongoing Stock Investing starting at: (110) Receive: Account Number entry means for a user/investor to transact business in their selected account, (111) Receive: Action transaction type means including: (111a) Buy, (111b) Sell, (111c) Change/Cancel to indicate the action to be taken, (112) Receive: Stock/ETF Symbol entry means to invest using the mnemonic trading symbol (ex. IBM) for the publically traded security, (113) Receive Quantity: to include (113a) share quantity, (113b) dollar quantity, and (113c) percentage quantity (sell orders only) for Dollar Cost Average entry means stated in share amount, dollar amount, and a percentage of shares (for sell orders) based on the number of shares held in the account at any given time. (114) Receive Maximum Investment Criteria: include (114a) Maximum Shares or (114b) Maximum Dollars to include accumulation totals of the maximum shares or dollars the user/investor wants to buy or sell on a selected security. (115) Receive: Start and End Dates from Calendar: (115a) Starting Date entry means to begin a Dollar Cost Average program (ex.09/30/2011), and (115b) Ending Date entry means to complete the program (ex. 09/30/2013) both chosen on a pop-up display calendar. (116) Receive: Investment Frequency (Choose one and edit calendar. Dates populate within timeframe of order): (116a) Daily, (116b) 4 Days/Week, (116c) 3 Days/Week, (116d) 2 Days/Week, (116e) 1 Day/Week, (1160 Monthly (Select Date(s) to automatically populate all months within time frame of order), (116g) Other (Select Random Date(s)) is provided in order for the user to choose how often their transactions are to take place from a calendar that populates the chosen criteria. (117) Order Price entry means is provided in order for the user to choose a Market or Limit order: via Market, Receive Time of Day: (117a) Hour and Minute to transaction the order between 9:30 a.m. and 4:00 p.m., (117b) At Opening Price, (117c) At Closing Price, (117d) Receive Limit Or Better price that the user/investor selects and must trade at the stated price to allow the order to be filled.

The system further includes optional order choices for both buy orders and sell orders. (118) Receive Optional Choices for Buy Order Choices: (118a) Reinvest Dividends entry means, (118b) Do Not Reduced for Dividend Adjustments entry means, (118c) Buy in Cash A/C entry means, (118d) Buy in Margin A/C (if available) entry means, (118e) Minimum Share Quantity entry means noting the least amount of shares to buy, (118f) All or None entry means to fill all shares or none at all.

And Receive Optional Sell Order Choices: (118e) Minimum Share Quantity entry means noting the least amount of shares to sell, (118f) All or None entry means to fill all shares or none at all, and Cost Basis entry means that defaults to First In First Out if user/investor does not select from the following choices: (118g) FIFO (default) shares purchases first and sold first, (118h) LIFO shares purchased last and sold first, (118i) HIGH COST shares with highest cost basis sold first, (118j) LOW COST shares with lowest cost basis sold first, (118k) TAX LOT OPTIMIZER lots are selected & sold with the objective of taking losses first and gains last, (1181) SPECIFIED LOT to assign specific lots to be sold at the time of trade up to settlement date. (119) Receive: Optional Funding Features In/Out from External Account entry means is provided to set-up an external bank/brokerage account to link funds to settle purchases created from DCA and to avoid interest fees if purchased on margin, and to also have the ability to send funds upon settlement out to the external financial institution when sale proceeds are created from DCA. The funding feature include: (119a) Name of Bank/Broker entry means for user/investor to fill in required information of the name of the external financial institution, (119b) Bank/Broker ABA# entry means to move funds between institutions, (119c) Bank/Broker Account entry means to debit or credit funds from or to the external financial institution, (119d) For Further Credit In/Out to External Account means such as a brokerage a/c to be credit or debit, (119e) Authorize Transfer of Debt created INTO Trading Account on Settlement Date of Transaction entry means giving authorization to move money INTO the trading account upon settlement when a debt is created from a purchase transaction, (119f) Maximum Dollars to Transfer INTO trading account on Settlement entry means limiting an amount to transfer INTO the trading a/c to avoid a possible overdrawn issue from the external financial institution, (119g) Authorize Transfer of Credit OUT of Trading Account on Settlement Date of Transaction entry means giving authorization to move the credit from a sales transaction OUT to the external financial Institution upon settlement, (119h) Maximum Dollars to Transfer OUT of trading account on Settlement entry means limiting an amount to transfer OUT of the trading a/c to the external institution. (120) Receive Optional Email Reminder to Review DCA Order is provided giving the user/investor a heads-up reminder to check their open orders and make adjustments or simply let them stand: (120a) 7 Days for a 1-week email reminder, (120b) 14 Days for a 2-week email reminder, (120c) 30 Days for a 30-day email reminder, (120d) 60 Days for a 60-day email reminder, (120e) Other: Enter Days ______ of your choice email reminder to allow for flexibility and freedom of choice to meet the needs of the investors timeframe, (120f) Enter email address enabling the user/investors emails to be entered/adjusted if not on file is provided, (121) Receive Optional Broker Use Only is provided to enable the broker to make changes. (121a) Commission/Adjustments means to update/change commissions as needed, (121b) Notes to Display on Confirmation means to add notes on a confirmation when user/investor instructs special notes for their record. The process further provides (122) Select Pre-Existing Order means that allows for adjustments to standing orders, (123) Change or Cancel Order means that allows for the change/cancel to take place, (124) Review Order means that allows user/investor to review order before submitting it, (125) Submit Order means that allows order to be entered and activated.

The order entry platform for providing dollar cost averaging for ongoing stock investing of the subject invention allows a user to automatically invest over time without having to constantly monitor and enter his/her buys and sells. This will ultimately capture, over a selected period of time, the highs and lows of the market, providing dollar cost averaging and often creating a greater rate of return over the long nm. The invention helps prevent lost opportunities that result from situations wherein a user/investor is too busy to monitor their investment accounts. The order entry system for providing dollar cost averaging for ongoing stock investing of the subject invention makes available to the general public through all participating NYSE and F1NRA member Brokerage firms the ability to both buy into and sell out of publically traded securities in any user/investors account.

Through the DCA order entry processing system of the subject invention virtually everyone will have the flexibility of choosing the Security he/she wants to buy into or sell out of over time, while having the choice of selecting the Quantity of Shares or Dollar amount and even Percentage Amount (for Sales Only), maximum accumulation totals, start and end dates to set up and the investment strategy, selecting the order frequency and to choose what day of the week, month, or on a random scheduled basis when the trade takes place, choosing a market or limit order and selecting the timing of when the order gets executed (market orders only), selecting optional criteria such as dividend reinvestment, do not reduce for dividend adjustment, buy in cash or margin a/c, minimum quantity of shares to trade before order is filled, all or none stipulation, cost basis selection on sales, link money funds from external account into and out of the trading account with the ability to cap out the funds to avoid a debt on the other side, optional periodic email reminders to view and make adjustments to the order, and the ability for Brokers to make adjustments to commissions and add notes to the user/investors confirmation. The platform provides investment flexibility, the ability to protect accounts when a user is trading on margin that can be problematic when a debt is created on a purchase causing the investor to be charged interest fees if the funds are not received in full on the settlement date.

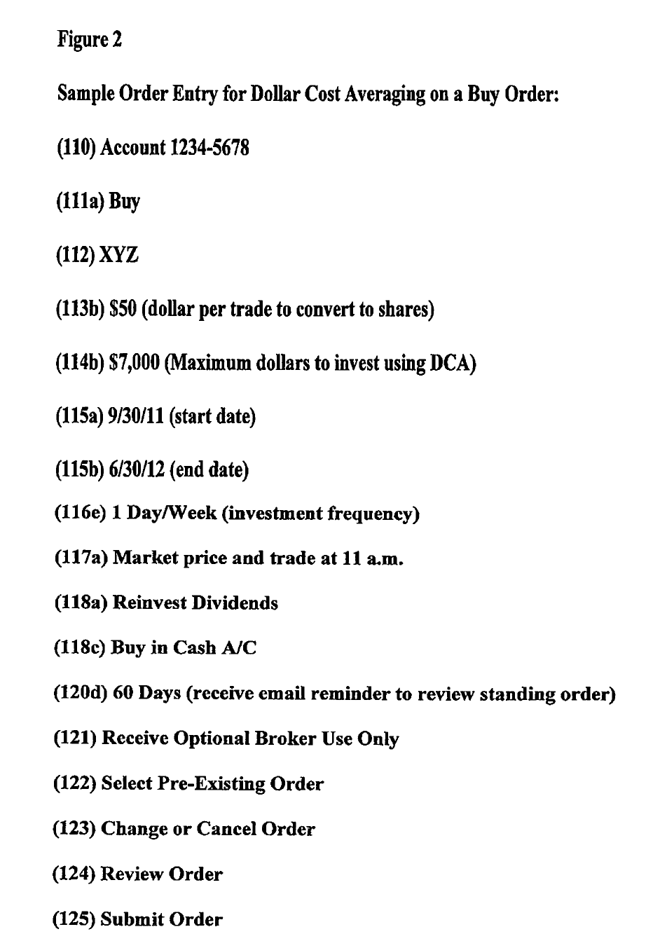

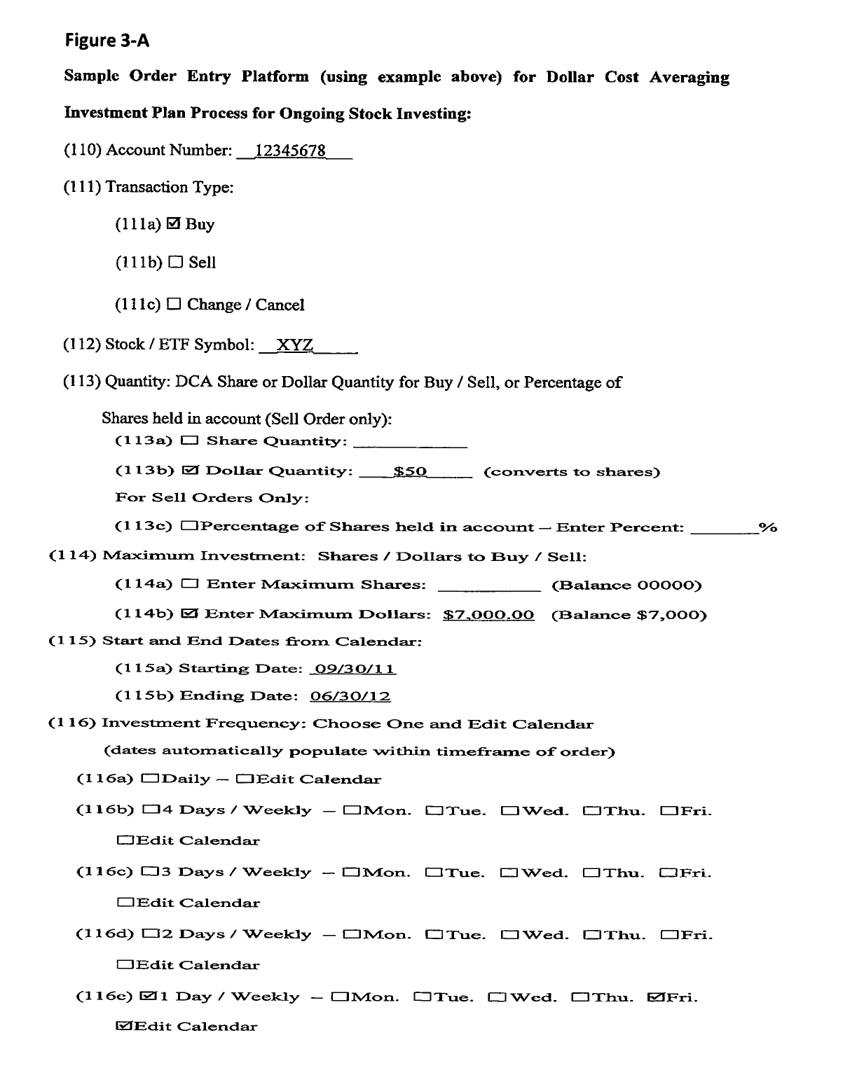

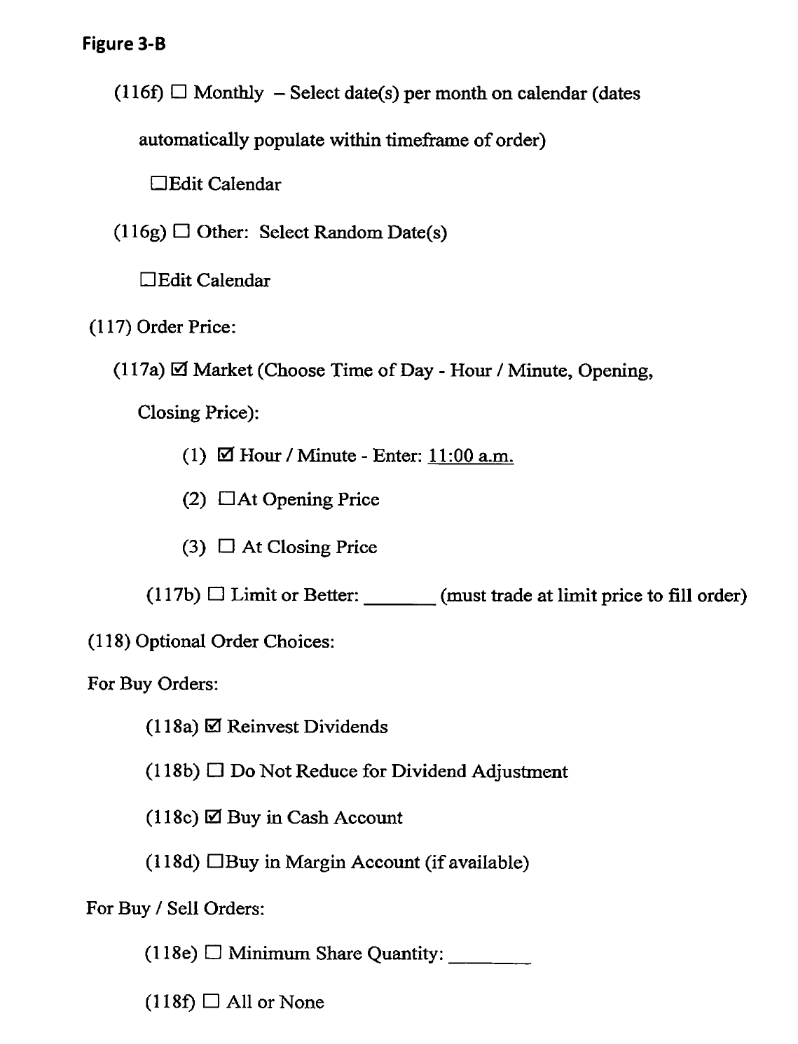

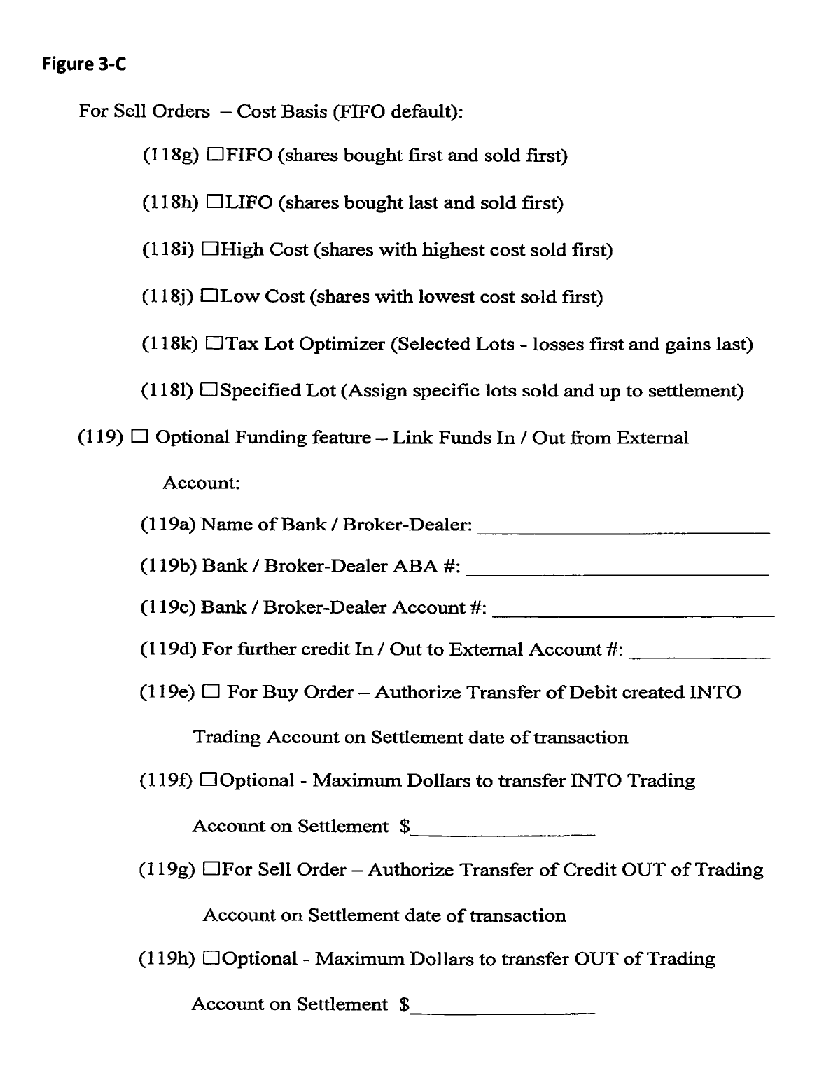

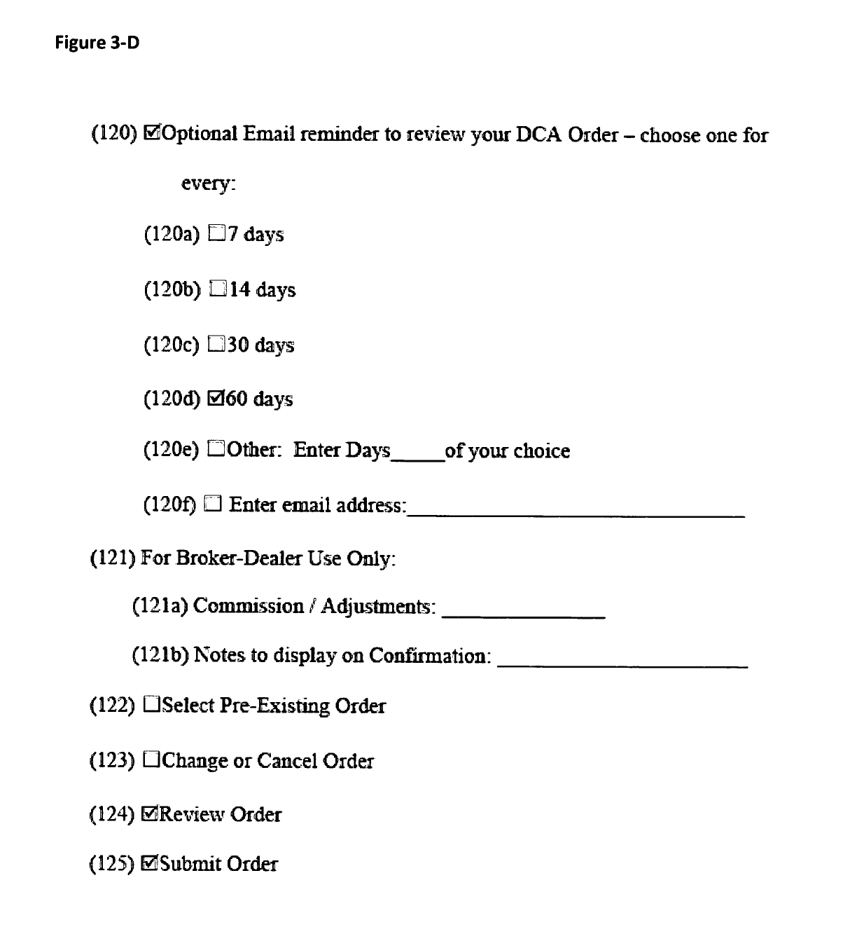

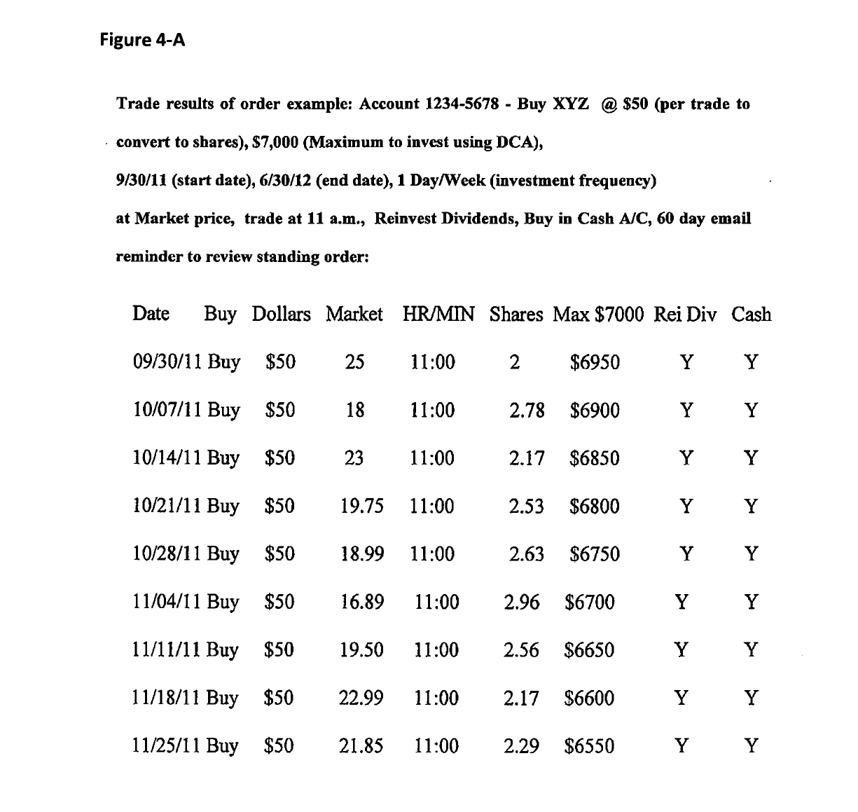

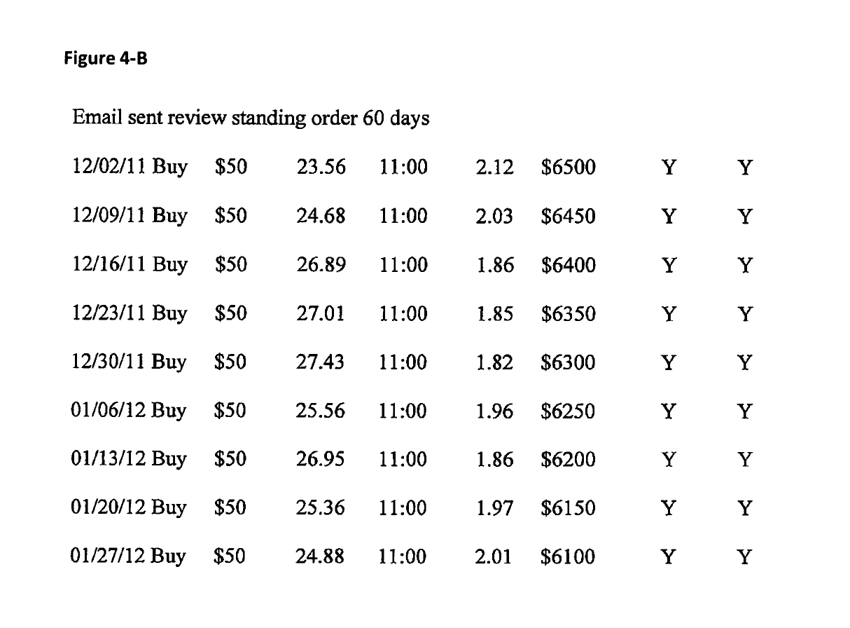

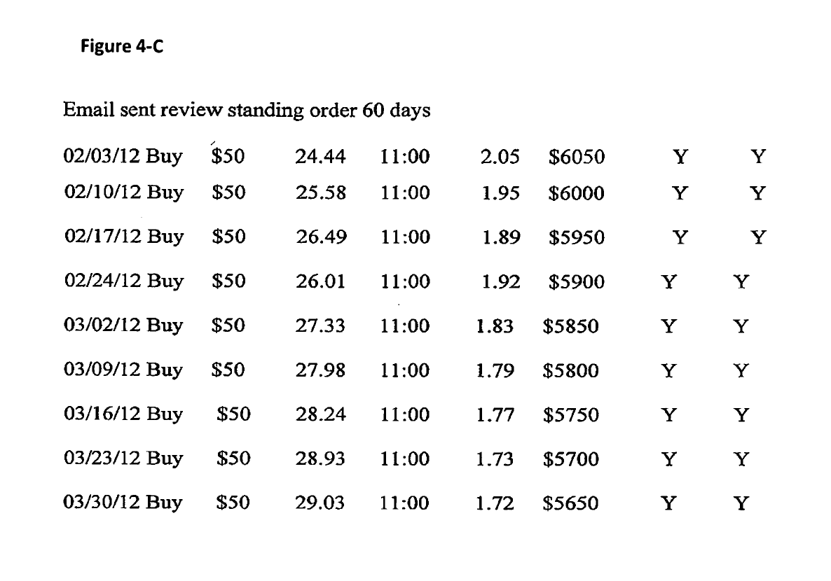

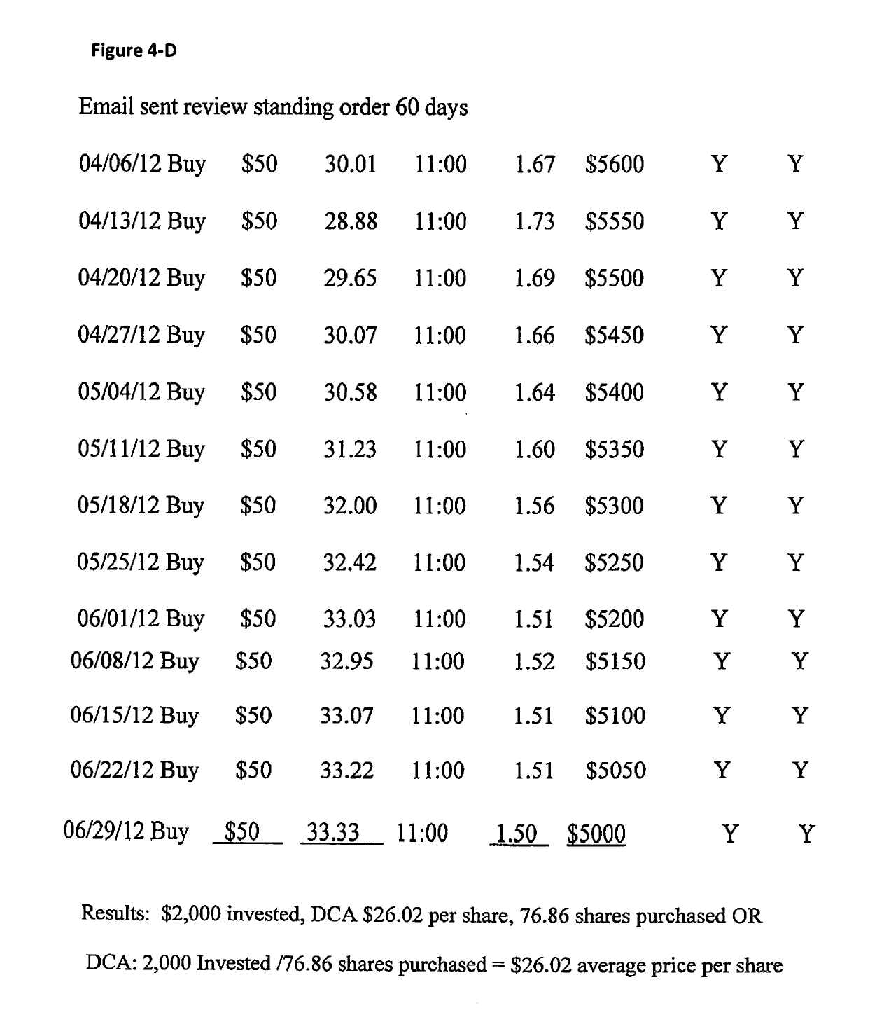

FIG. 2 is an example of an order entry for Dollar Cost Averaging on a Buy Order. FIG. 3-A is an order Entry Platform (using example in FIG. 2) using the subject Dollar Cost Averaging Investment Plan Process for Ongoing Stock Investing. FIGS. 3-B through 3-D further illustrate the Dollar Cost Averaging Investment Plan Process for Ongoing Stock Investing on a Buy Order. FIGS. 4-A though 4-D illustrates Trade results of the order example of FIGS. 3-A through 3-D. FIGS. 4-B through 4-D illustrate email notifications sent for review of the standing order at 60 day intervals through the end date of the order, herein June 29^{th}, with final results and information posted.

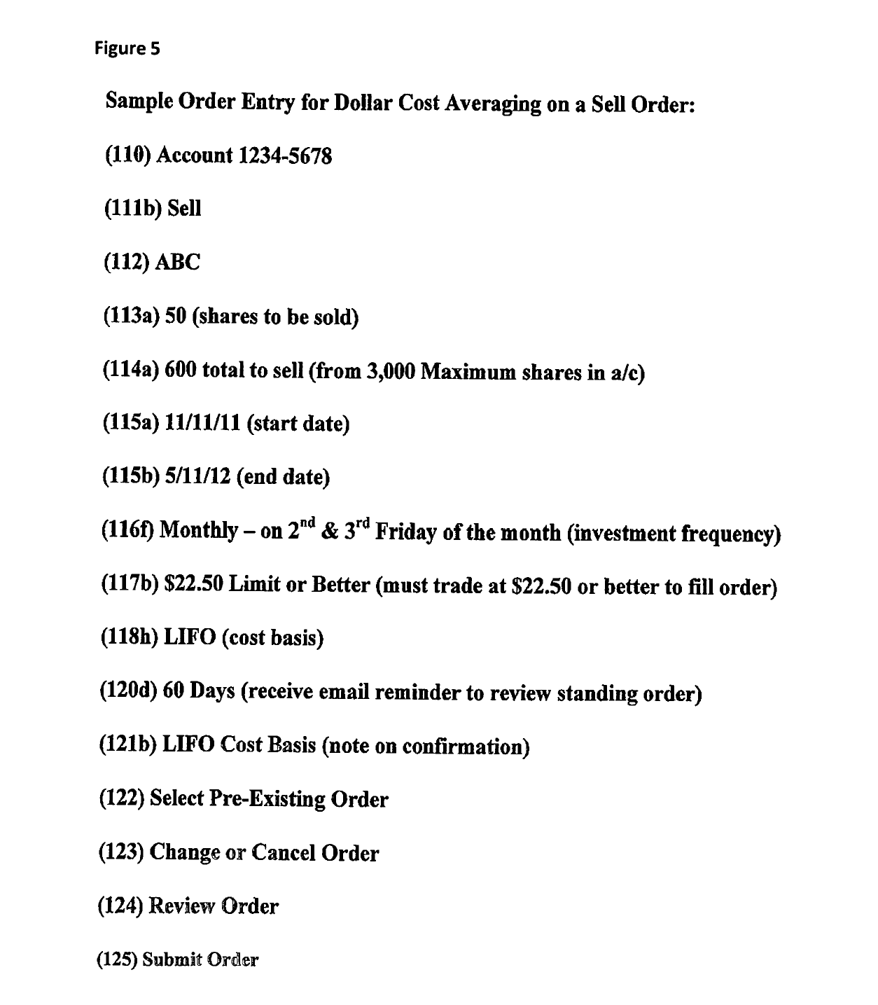

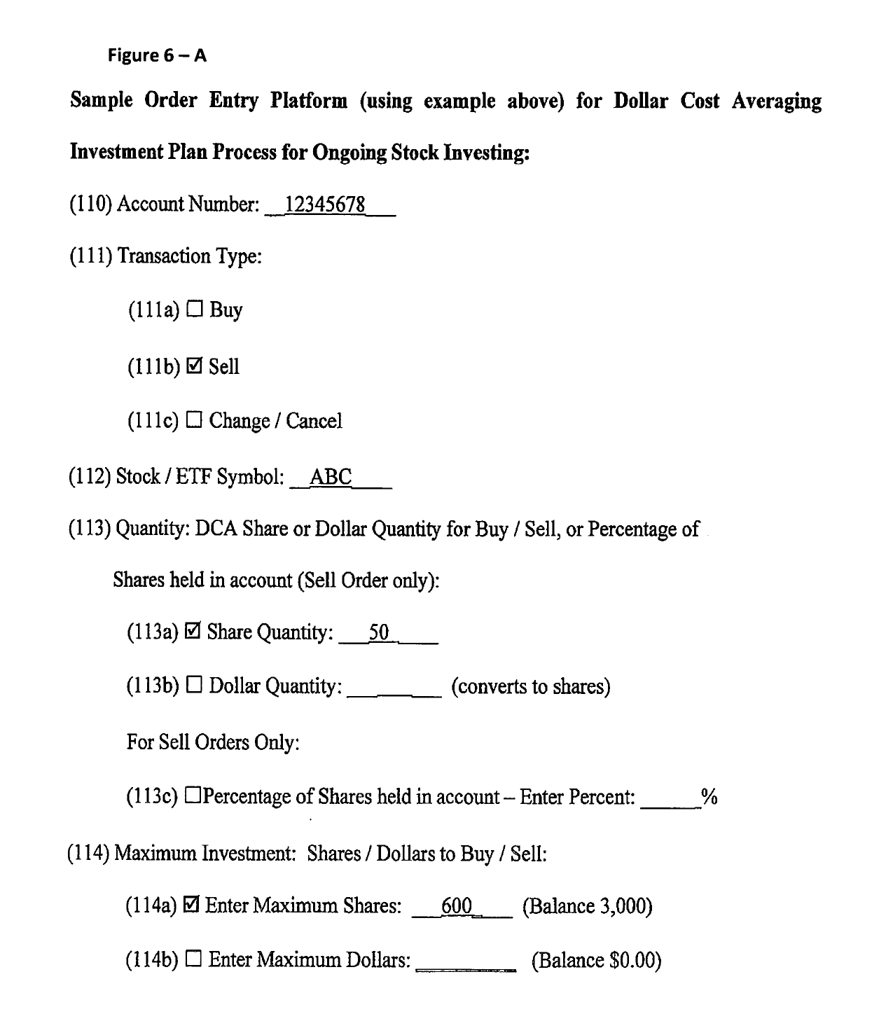

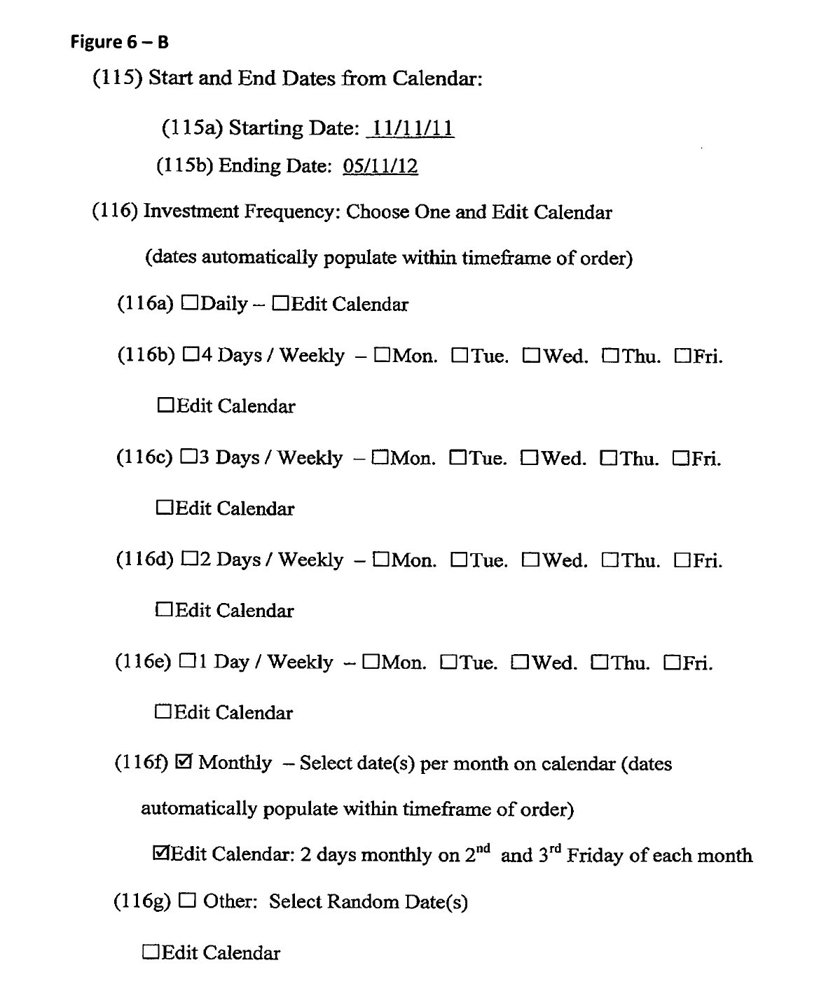

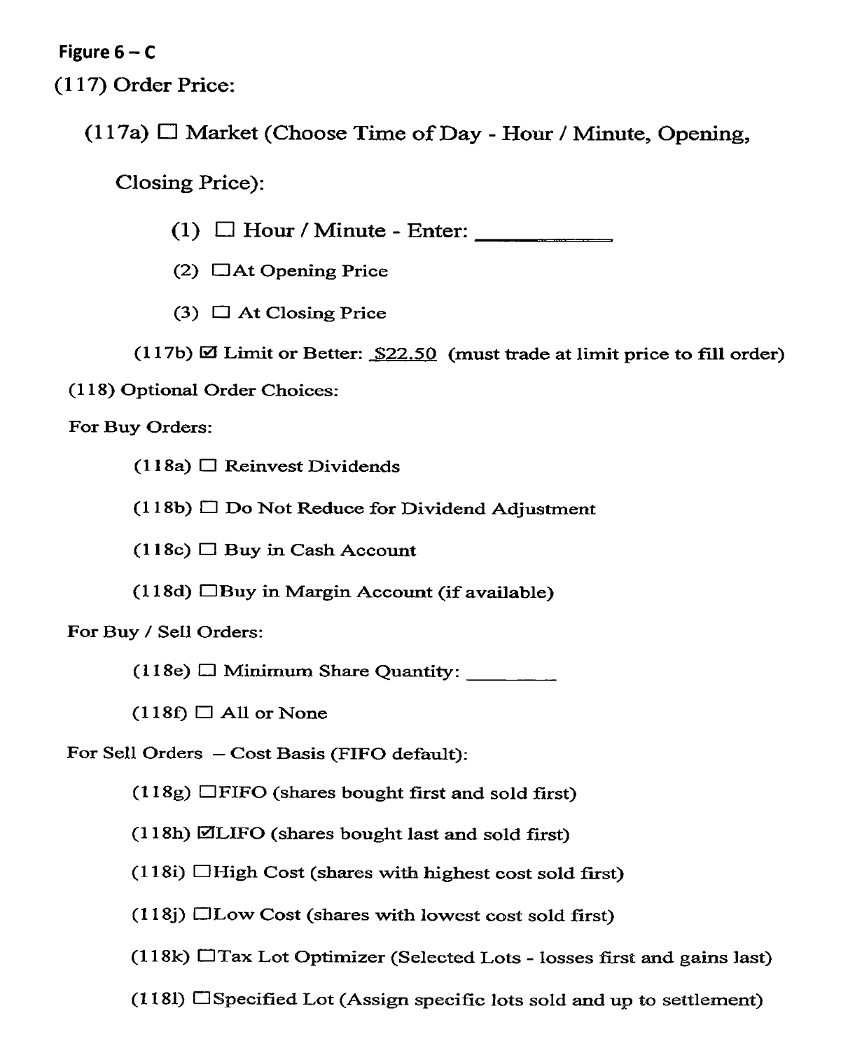

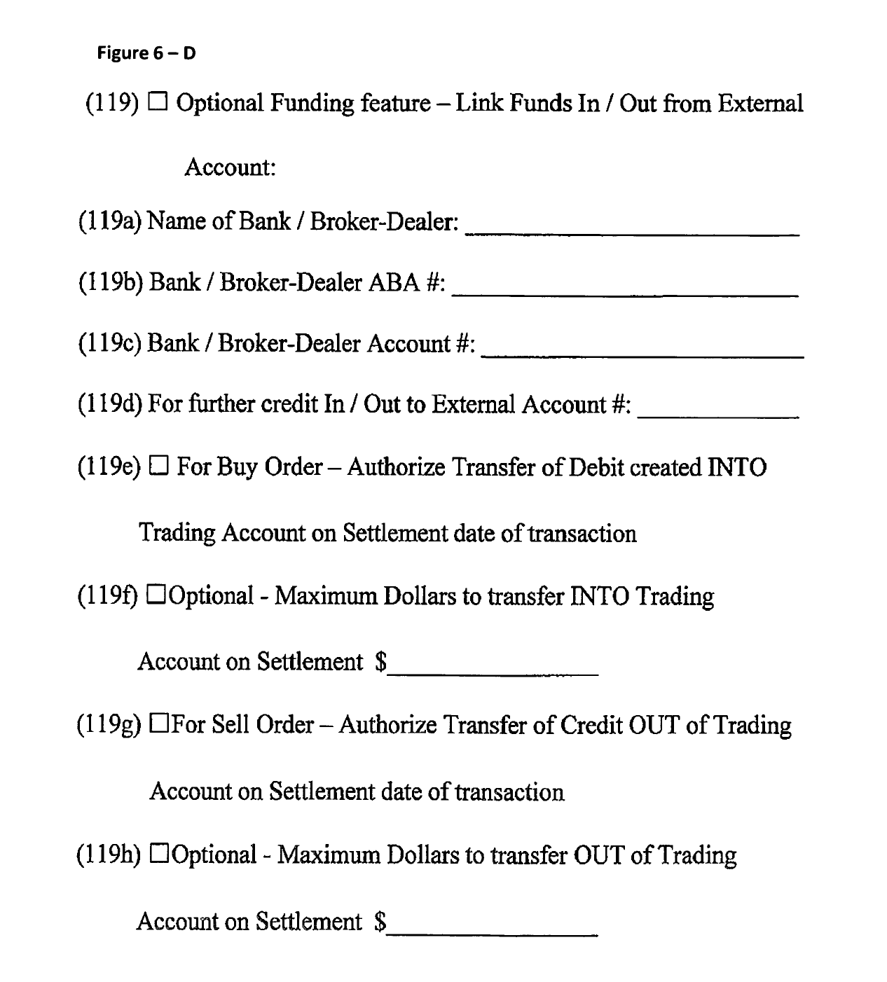

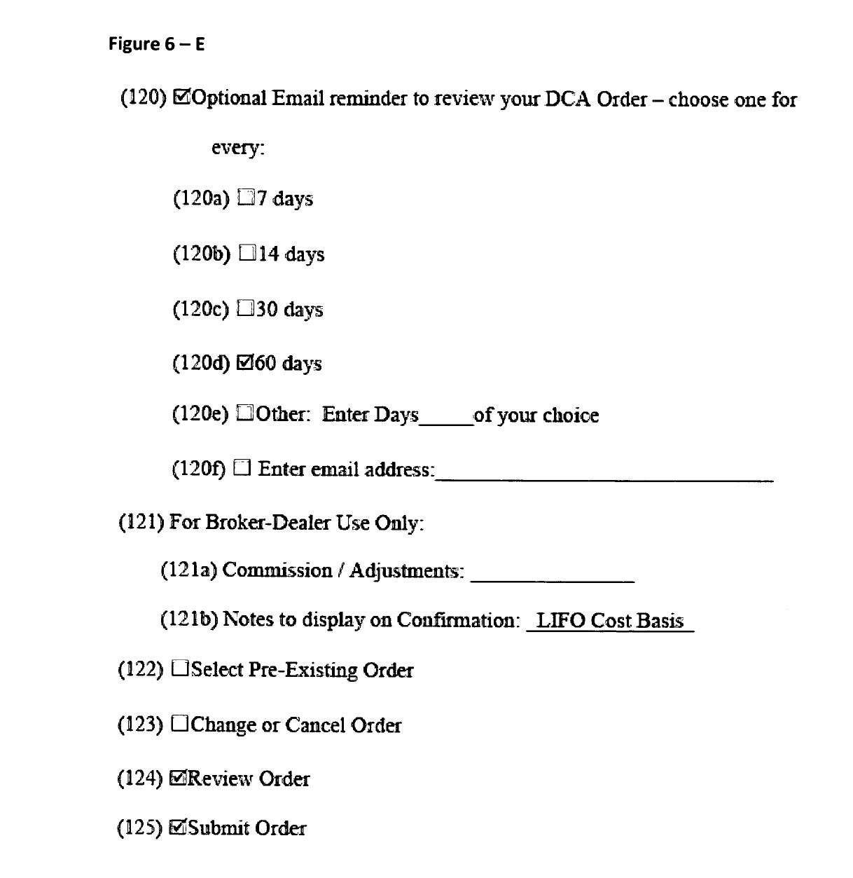

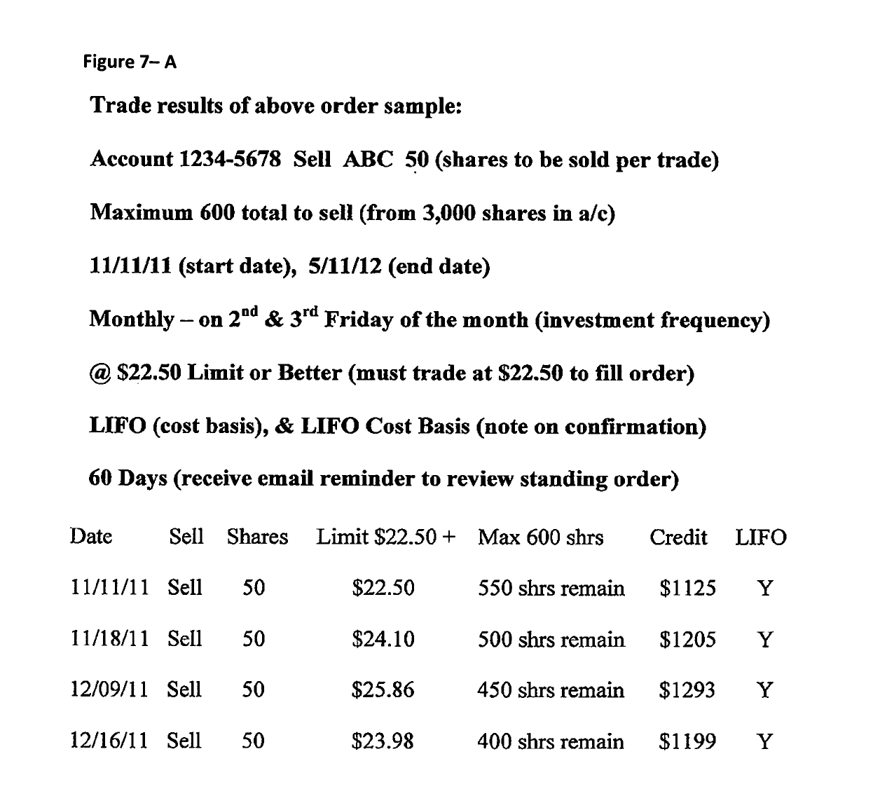

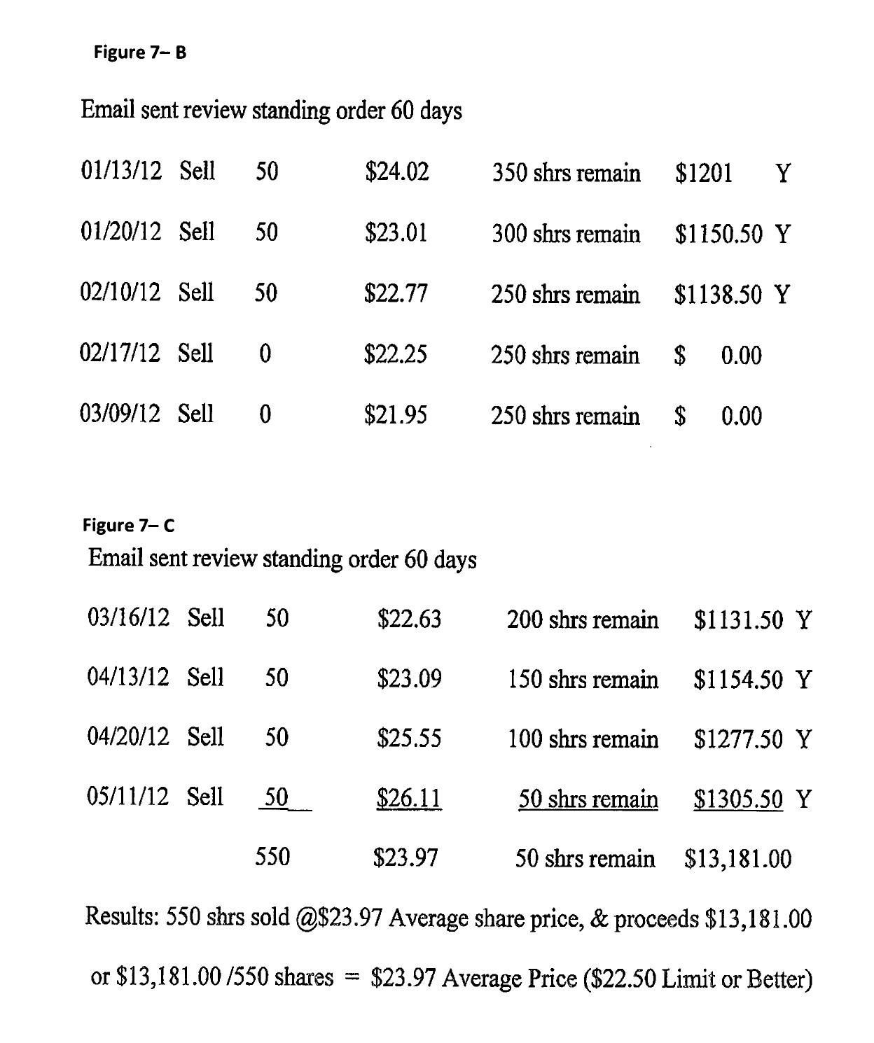

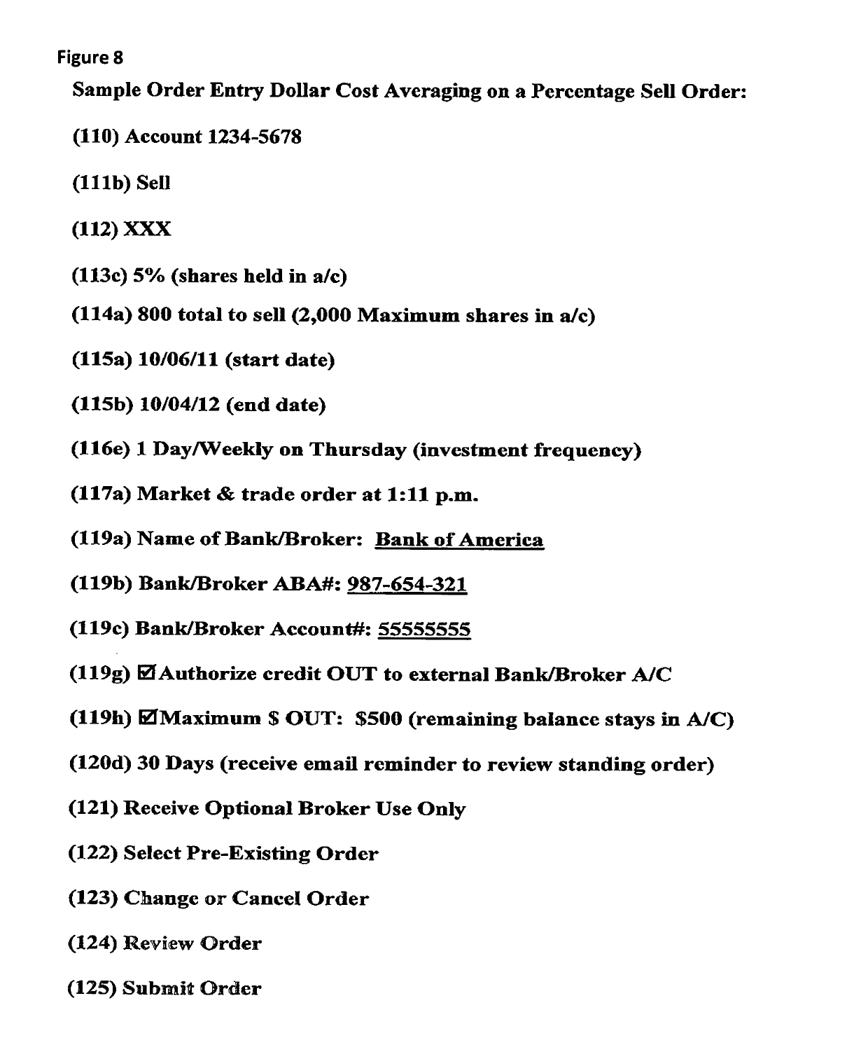

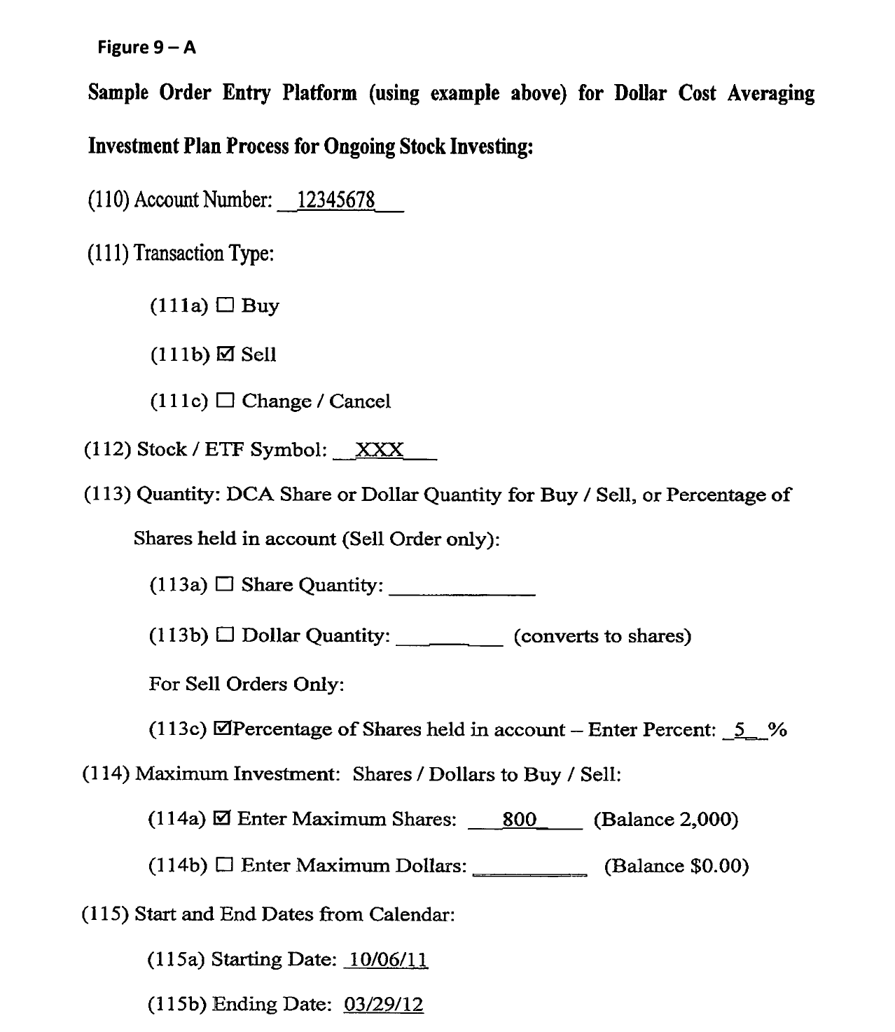

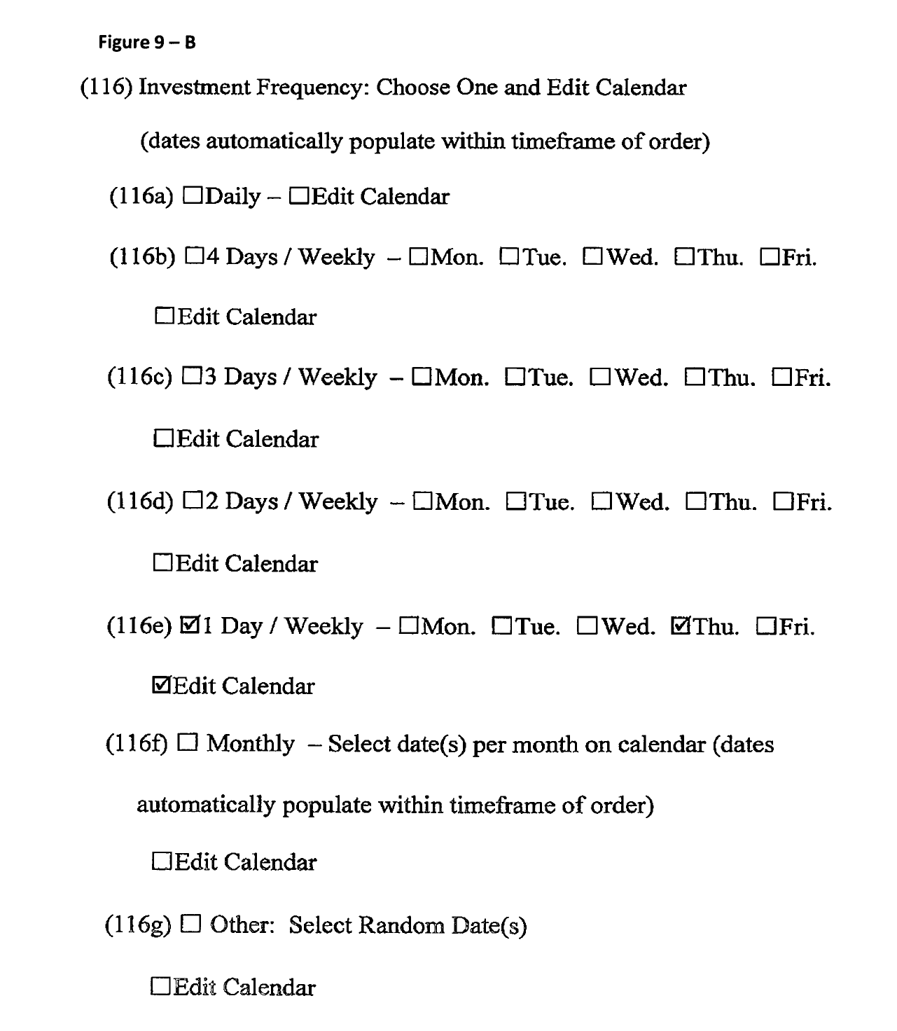

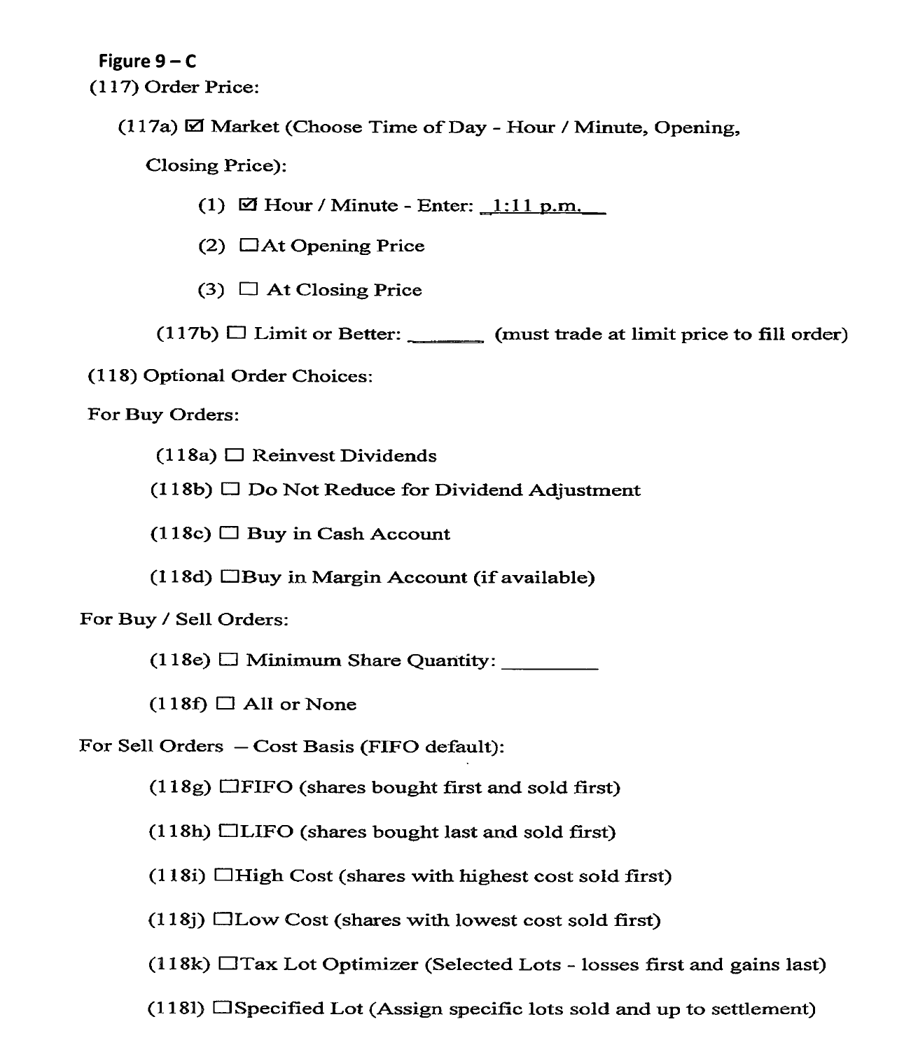

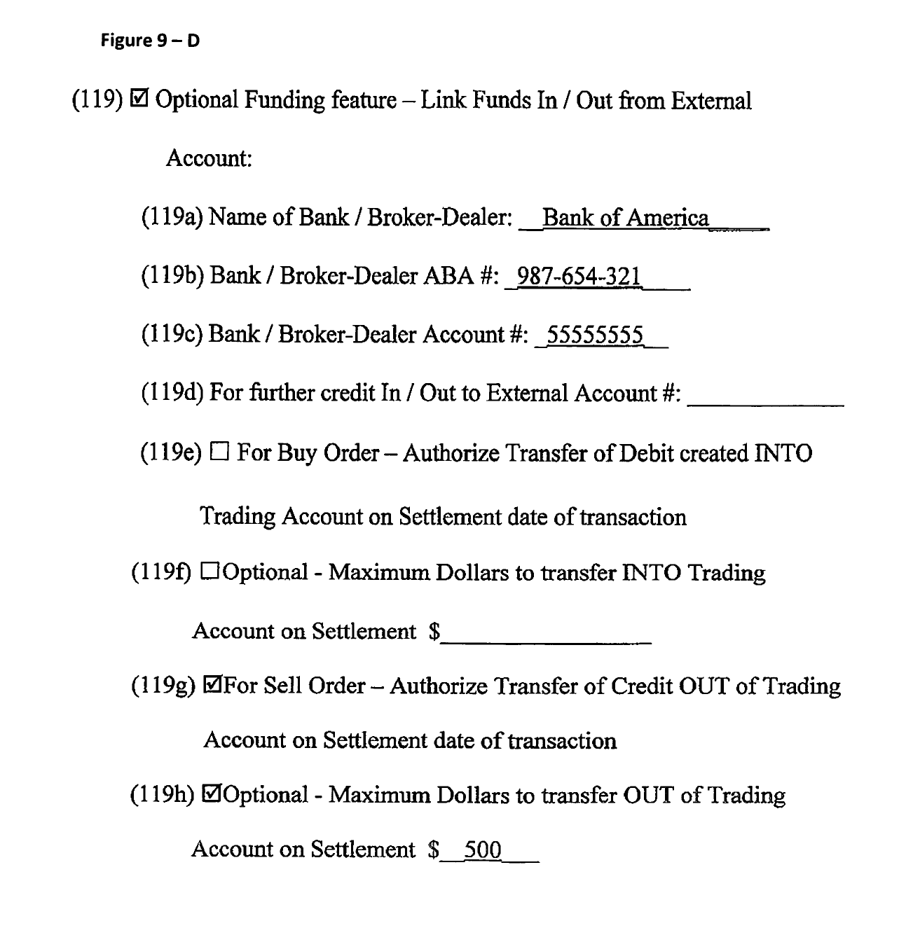

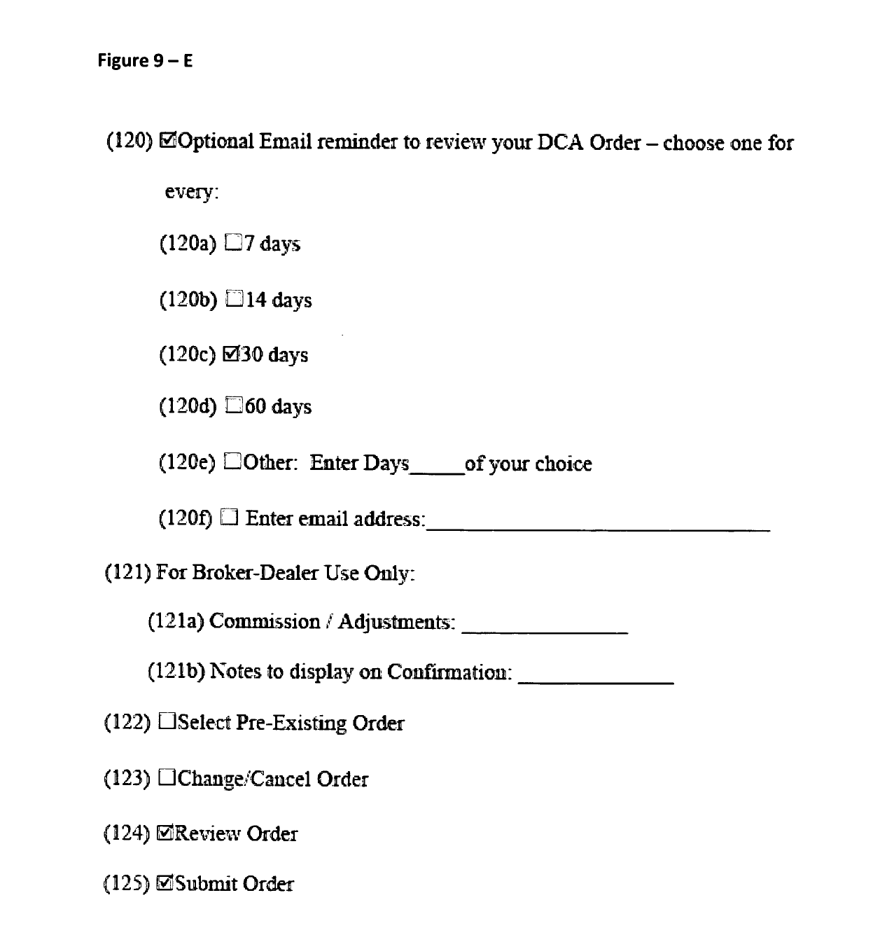

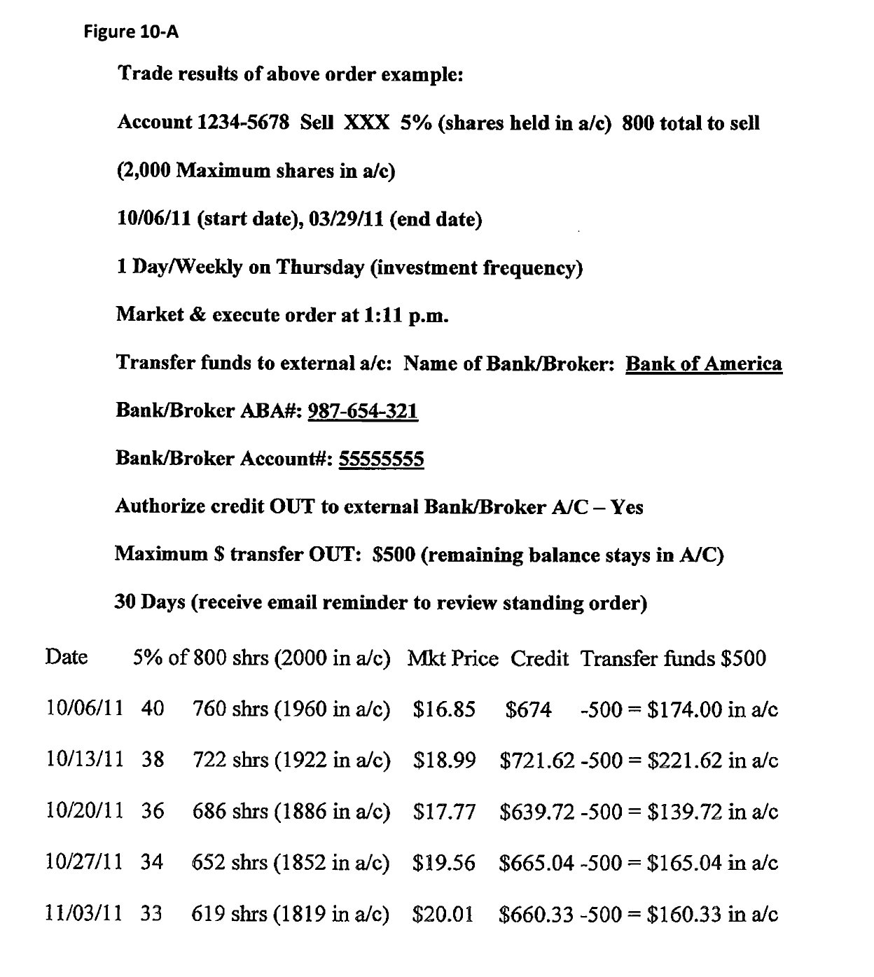

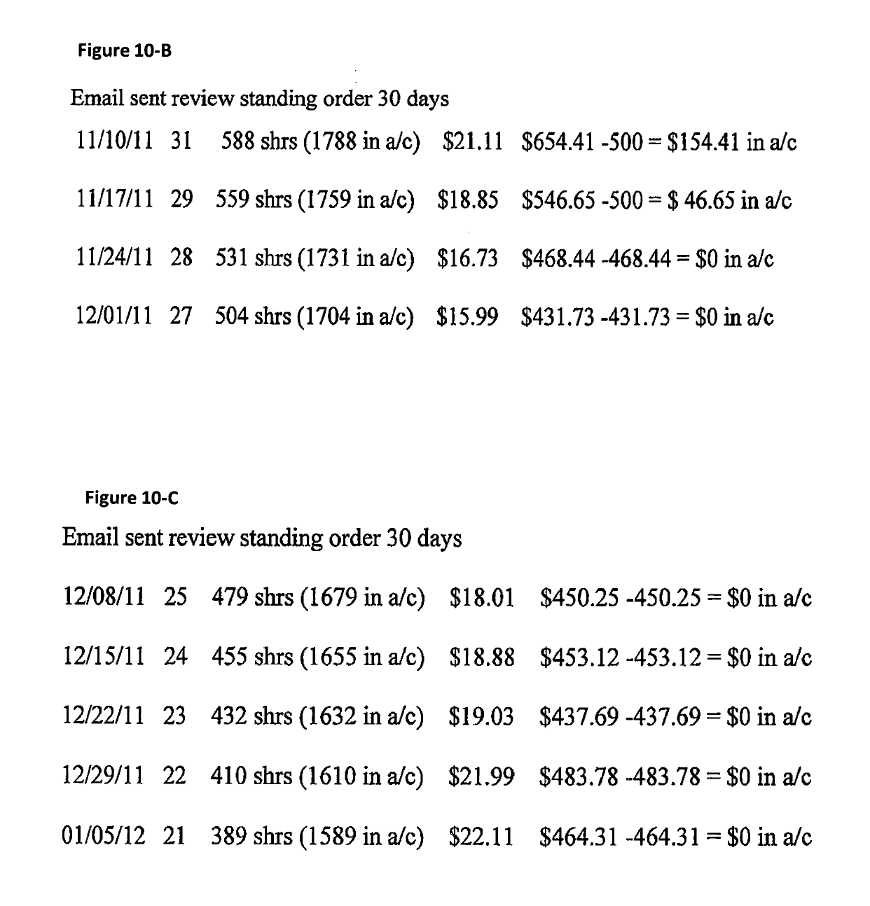

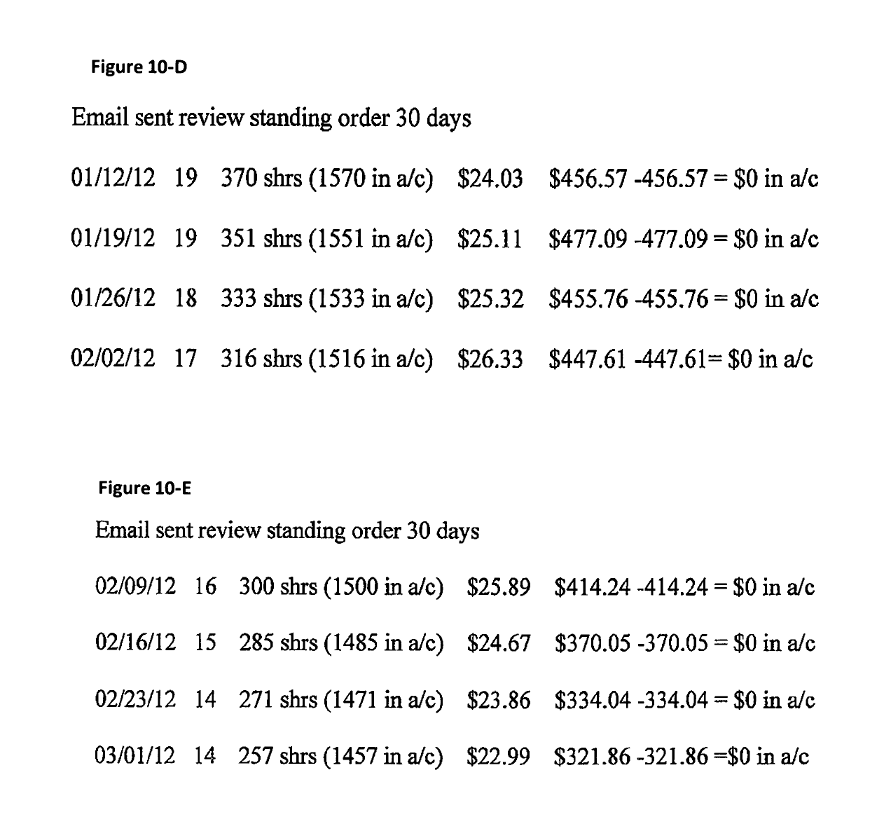

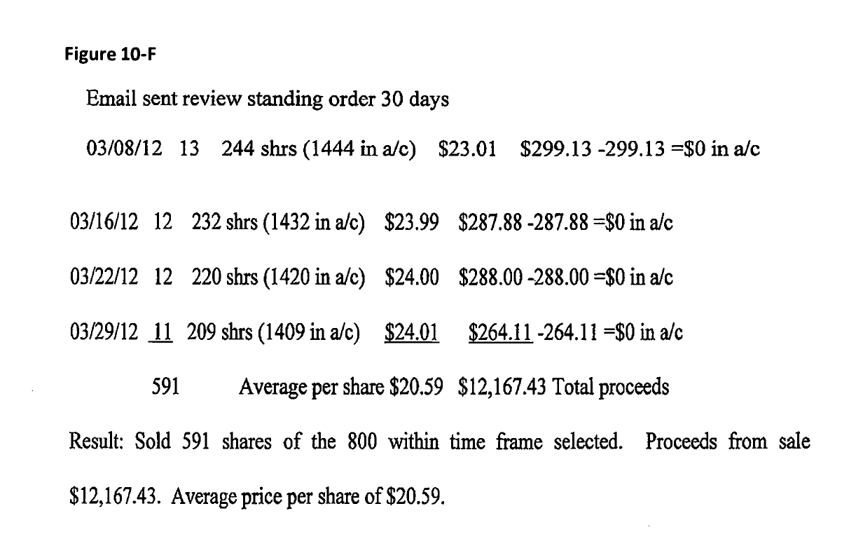

FIG. 5 is an example of an order entry for Dollar Cost Averaging on a Sell Order. FIGS. 6-A though 6-E show an order Entry Platform (using example in FIG. 5) using the subject Dollar Cost Averaging Investment Plan Process for Ongoing Stock Investing. FIGS. 7-A through 7-C illustrate Trade results of the order example of FIGS. 6-A through 6-E, including email/notifications sent for review of the standing order at 60 day intervals ending May 11th, with final results and information posted. FIG. 8 is an example of an order entry for Dollar Cost Averaging on a Percentage of Shares Sell Order. FIGS. 9-A through 9-E show an order Entry Platform (using example in FIG. 8) using the subject Dollar Cost Averaging Investment Plan Process for Ongoing Stock Investing. FIGS. 10-A through 10-F illustrate Trade results of the order example of FIGS. 9-A through 9-E, including email/notifications sent for review of the sell order at 30 day intervals with final results posted.

Referring to FIGS. 1-10, the order entry process for the proposed system platform creates an automatic investment plan utilizing the method of Dollar Cost Averaging will include the following data to be integrated into I.T. systems for Broker-Dealers and Electronic Trading systems for online Internet investing that are available for the user/investor. Note: Please refer to the Flowchart FIG. 1 for details—(110) Receive: Account Number entry means for a user/investor to transact business in their selected account, (111) Receive: Action transaction type means for: Buy, Sell, Change/Cancel to indicate the action to be taken, (112) Receive: Stock/ETF Symbol entry means to invest using the mnemonic trading symbol (ex. IBM) for the publically traded security, (113) Receive Quantity: Share Quantity, Dollar Quantity, Percentage Quantity (sell orders only) for Dollar Cost Average entry means stated in share amount, dollar amount, and a percentage of shares (for sell orders) based on the number of shares held in the account at any given time or selected by the user/investor, (114) Receive Maximum Investment Criteria: Maximum Shares or Maximum Dollars to include an accumulation total of the maximum shares or dollars the user/investor wants to buy or sell on a selected security, (115) Receive: Start and End Dates from Calendar: Starting Date entry means to begin a Dollar Cost Average program (ex. 09/30/2011), and Ending Date entry means to complete the program (ex. 09/30/2013) both chosen on a pop-up display calendar, (116) Receive: Investment Frequency order entry means to choose how often the user/investors transactions are to take place from a calendar that populates the chosen Criteria: Daily, 4 Days/Week, 3 Days/Week, 2 Days/Week, 1 Day/Week, Monthly (Select Date(s) to automatically populate all months within time frame of order), or Other (Select Random Date(s)), (117) Order Price entry means to choose a Market or Limit order with the flexibility to choose the Hour and Minute to transact the order between 9:30a.m. and 4:00 p.m., or At Opening Price, or At Closing Price, or Limit order or Better price that the user/investor selects and must trade at the stated price to allow the order to be filled. The system further includes optional order choices for both buys and sells, (118) Receive: Optional Order Choices for Buy Order: Reinvest Dividends entry means, Do Not Reduced for Dividend Adjustments entry means, Buy in Cash A/C entry means, Buy in Margin A/C (if available) entry means and maybe subject to interest charges if debt is created, Minimum Share Quantity entry means noting the least amount of shares to buy or sell on a limit order, All or None entry means to fill all shares or none at all for both buy and sell limit orders, Optional Order Choices for Sell Order: Cost Basis entry means that defaults to First In First Out if user/investor does not select from the following choices: FIFO (default) shares purchases first and sold first, LIFO shares purchased last and sold first, HIGH COST shares with highest cost basis sold first, LOW COST shares with lowest cost basis sold first, TAX LOT OPTIMIZER lots are selected & sold with the objective of taking losses first and gains last, SPECIFIED LOT to assign specific lots to be sold at the time of trade up until settlement date, (119) Receive: Optional Funding Features In/Out from External Account entry means to set-up an external bank/brokerage account to link funds to settle purchases created from DCA and to avoid interest fees if purchased on margin, and to also have the ability to send funds upon settlement out to the external financial institution when sale proceeds are created from DCA, Name of Bank/Broker entry means for user/investor to fill in required information of the name of the external financial institution, Bank/Broker ABA# entry means to move funds between institutions, Bank/Broker Account # entry means to debit or credit funds from or to the external financial institution, For Further Credit In/Out to External Account such as a brokerage a/c to be credit or debit, Authorize Transfer of Debt created INTO Trading Account on Settlement Date of Transaction entry means giving authorization to move money INTO the trading account upon settlement when a debt is created from a purchase transaction, Maximum Dollars to Transfer INTO trading account on Settlement entry means limiting an amount to transfer INTO the trading a/c to avoid a possible overdrawn issue from the external financial institution, Authorize Transfer of Credit OUT of Trading Account on Settlement Date of Transaction entry means giving authorization to move the credit from a sales transaction OUT to the External Financial Institution upon settlement, Maximum Dollars to Transfer OUT of trading account on Settlement entry means limiting an amount to transfer OUT of the trading a/c to the external institution (120) Receive: Optional Email Reminder to Review DCA Order gives the user/investor a heads-up reminder to check their open orders and make adjustments or simply let them stand: Days to send an email reminder, 7 Days, 14 Days, 30 Days, 60 Days, and Other: Enter Days ______ of your choice, enabling user to create their own email reminder, Enter email address enabling the user/investors emails to be entered/adjusted if not on file, (121) Receive: Optional Broker Use Only to enable the broker to make adjustments/changes to commission, and add notes to display on user/investors confirmation to be added for their records, (122) Select Pre-existing Order means to allow a user/investor to select a standing order, (123) Change/Cancel Order means to adjusts or cancel the order, (124) Review Order allows user/investor to review order before submitting it, (125) Submit Order allows order to be entered and activated.

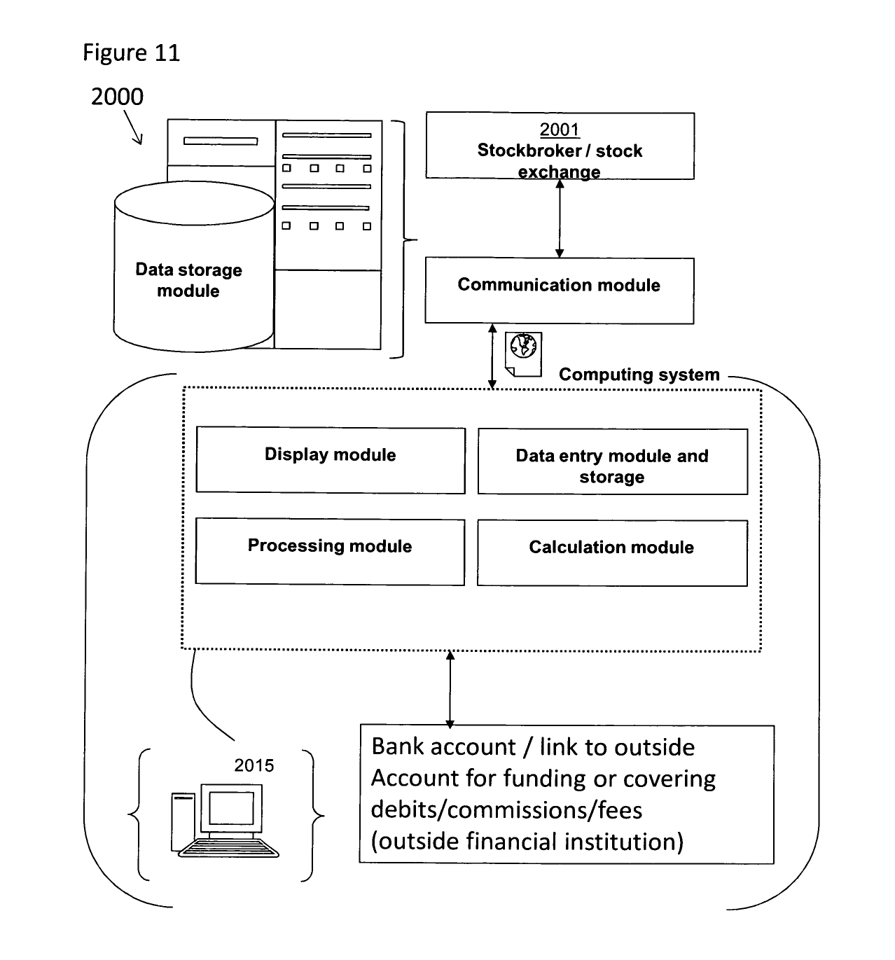

FIG. 11 is a block diagram of the computerized system of the present invention. The system connects to a server 2001 which may be the Broker-Dealers server, or may be a server on the stock exchange and may be established by the internet. The processing system for providing a DCA investment plan process for ongoing stock investing may consist of a computer 2015 of a user/investor which may have a monitor, keyboard and mouse attached, or may be a microprocessor based platform. A graphic user interface is provided, and may both contain the user interface itself, and may contain functionality to perform decisions without the interference of the user, or may be with limited or without user interference. The processing system for providing a DCA investment plan process for ongoing stock investing may also communicate with other external units, the connection may be established by the internet. Sources of information are stored in a database, and may provide the DCA investment plan process system with information such as price, price monitoring, or other relevant information. The user's computer 2015 may be further linked to a bank account or funding account for money transfers for purchase transactions, or to cover debits, fees, and/or commissions to avoid a debit of the investment account and also have the ability to send money out to the external financial institutions upon request.

The Broker-Dealers server transmits and receives data to and from the computing system via a communication module via the Internet. The communication module transmits and receives data, to and from the computing system via any standard electronic means known in the art. The computing system generally comprises: a display module, data entry module, processing module, and calculation module. As used herein the data storage module is also referred to as a storage device or can be the I.T. systems of a Broker who utilize the Intellectual Property Method for DCA Investment

Plan Process for Ongoing Stock investing. A processing module is coupled to the storage device, the storage device storing instructions that are utilized by the processor. The instructions comprise entry of the information and steps as set forth in the flowchart FIG. 1, and FIGS. 2-10F.

The above detailed illustrative embodiments are presented to provide a more complete understanding of the invention. The specific techniques, systems, and operating structures set forth to illustrate the principles and practice of the invention may be embodied in a wide variety of sizes, shapes, forms and modes, some of which may be quite different from those in the disclosed embodiment. Consequently, the specific structural and functional details disclosed herein are exemplary. They are deemed to afford the best embodiment for purposes of disclosure; but should not be construed as limiting the scope of the invention.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. A system for implementing a dollar cost averaging investment plan process (DCA) for ongoing stock investing, comprising:
a. an order entry means that prompts a user for an account number;
b. a receive action means for selecting a transaction to buy, sell, change or cancel an order;
c. Stock/ETF symbol entry means for entry of an investment vehicle;
d. a quantity entry means to indicate the amount of shares, dollars, or a percentage of shares (for sell orders only) to be purchased or sold during said DCA for ongoing stock investing;
e. a maximum investment criteria means to cap the amount of shares or dollars to invest;
f. a start date and end date entry means to provide a beginning and ending to a DCA plan;
g. an Investment frequency to allow investor to set up a daily, weekly, monthly, or random choice plan to invest into said DCA plan;
h. order price choices of market or limit price with the ability to choose the time during market hours to execute a market order (ex. 11:00 a.m.) or at the open or closing price;
i. an optional order choices for buy and sell orders to allow for dividend reinvestment, do not reduce for dividend adjustment, buy in cash or margin a/c, minimum share quantity, all or none, and for sales allowing user to choose cost basis;
j. an optional funding feature In and Out of the trading a/c to access an funds from an external a/c;
k. an optional email reminder to allow for periodic monitoring of the DCA plan;
l. an optional broker use only selection allowing for adjustments to commission and to display notes on an investors confirmation;
m. a select pre-existing order to allow access for changes
n. a change or cancel order access to allow investor to change or cancel order
o. a review order means to review and double check for accuracy before entering order;
p. a submit order means to allow for the order to be sent to the exchange for processing.

2. A system for implementing a dollar cost averaging investment plan process (DCA) for ongoing stock investing at recited by claim 1 comprising of an order entry means prompting a user for an account number.

3. A system for implementing a dollar cost averaging investment plan process (DCA) for ongoing stock investing at recited by claim 1 comprising of an action to create a transaction to buy, sell, or change/cancel an order.

4. A system for implementing a dollar cost averaging investment plan process (DCA) for ongoing stock investing at recited by claim 1 comprising of a stock/ETF symbol to enter an investment vehicle.

5. A system for implementing a dollar cost averaging investment plan process (DCA) for ongoing stock investing at recited by claim 1 comprising a quantity entry means to indicate the amount of shares, dollars, or a percentage of shares (for sell orders only) to be purchased or sold during the said DCA plan.

6. A system for implementing a dollar cost averaging investment plan process (DCA) for ongoing stock investing at recited by claim 1 comprising of a maximum investment criteria means not to exceed a stated amount of shares or dollars to buy or sell during said DCA plan.

7. A system for implementing a dollar cost averaging investment plan process (DCA) for ongoing stock investing at recited by claim 1 comprising of a start date to begin and an end date to complete the DCA plan.

8. A system for implementing a dollar cost averaging investment plan process (DCA) for ongoing stock investing at recited by claim 1 comprising an investment frequency allowing an investor to set up a daily, weekly, monthly, or random choice invest plan.

9. A system for implementing a dollar cost averaging investment plan process (DCA) for ongoing stock investing at recited by claim 1 comprising of an order price choice of market or limit (or better) order allowing the investor to choose the time of day to execute their orders when entering a market order.

10. A system for implementing a dollar cost averaging investment plan process (DCA) for ongoing stock investing at recited by claim 1 comprising an optional order choice means for buying and selling to allow dividend reinvestment, do not reduce for dividend adjustment, buy in cash or margin a/c, minimum share quantity, all or none, and for sales allowing the investor to choose their cost basis for tax purposes of FIFO (default), LIFO, High Cost, Low Cost, Tax Lot Optimizer, and Specified Lot.

11. A system for implementing a dollar cost averaging investment plan process (DCA) for ongoing stock investing at recited by claim 1 comprising of an optional funding feature in/out from an external funding source to allow settlement of trades to be credited or debited into or out of the brokerage account and capping the amount to go in and out to prevent shortages on either end.

12. A system for implementing a dollar cost averaging investment plan process (DCA) for ongoing stock investing at recited by claim 1 comprising of an optional email reminder to allow the investor to choose the times they wish to be reminder to look at their DCA plan and make adjustments if needed.

13. A system for implementing a dollar cost averaging investment plan process (DCA) for ongoing stock investing at recited by claim 1 comprising of an optional broker means to make adjustments to commissions and display notes on an investors confirmation.

14. A system for implementing a dollar cost averaging investment plan process (DCA) for ongoing stock investing at recited by claim 1 comprising of a select pre-existing order to allow access for changes.

15. A system for implementing a dollar cost averaging investment plan process (DCA) for ongoing stock investing at recited by claim 1 comprising of a change or cancel order access to allow an investor to adjust an order.

16. A system for implementing a dollar cost averaging investment plan process (DCA) for ongoing stock investing at recited by claim 1 comprising of a review order means to double check for accuracy before entering the order.

17. A system for implementing a dollar cost averaging investment plan process (DCA) for ongoing stock investing at recited by claim 1 comprising of a submit order means allowing the order to be sent to the exchange for processing.

18. A processing system for demonstration purposes to show a workflow for use of dollar cost averaging investment plan process for ongoing stock investing utilizing a potential Broker-Dealers I.T. system:
1. a storage device;
2. a processor coupled to the storage device, the storage device storing data that is utilized by the processor, the data accumulated by means comprising:
i. an order entry means that prompts a user for an account number;
ii. an action option means to buy, sell, change, or cancel a transaction;
iii. symbol entry means for entry of a stock or ETF;
iv. quantity entry means entered in amount of shares, dollars, and percentages;
v. maximum investment criteria capping the amount of shares/dollars;
vi. start and end date entry means to begin and complete DCA plan;
vii. investment frequency to set up daily, weekly, monthly, random investing plan;
viii. order price choices of market, limited, open or close price, and hour of day;
ix. optional choice for buys and sells for dividend reinvestment, do not reduce, buy in cash/margin a/c, minimum share quantity, all or none, and cost basis;
x. optional funding feature in and out of trading a/c to an external financial a/c;
xi. optional email reminder for periodic monitoring DCA plan;
xii. optional broker use to adjust commissions and place notes on confirmations;
xiii. select pre-existing order to access for updates;
xiv. change or cancel means to update or cancel;
xv. review order means to check before submitting an order;
xvi. submit order to send an order to the exchange;
